(19) United States
(12) Patent Application Publication
(10) Pub. No.: US 2003/0189920 A1
(43) Pub. Date: Oct. 9, 2003

(54) Transmission device with data channel failure notification function during control channel failure

(76) Inventors: Akihisa Erami, Fukuoka (JP); Hiroshi Kinoshita, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/269,545

(22) Filed: Oct. 11, 2002

(30) Foreign Application Priority Data
Apr. 5, 2002 (JP) 2002-104148

(51) Int. Cl. H04L 12/28

(52) U.S. Cl. 370/351; 370/466

(57) ABSTRACT

The present invention provides a transmission network system, which can discover the location of a failure of a data channel during a control channel failure. When a first transmission device located at a downstream side of a working path detects a failure of a working data channel for transmitting data signals to be input to the first transmission device along the working path during a control channel failure, it notifies the failure of the working channel to a second transmission device located at an upstream side of the working path via a bypass control channel. The second transmission device judges the location of the failure based on positional relationship between the second and first transmission devices, and based on presence of a failure of a working data channel for transmitting data signals to be input to the second transmission device along the working path.

### BACKGROUND OF THE INVENTION

1. Field of the Invention

The present invention relates to a transmission device for transmitting data signals in a transmission network system where a data channel for transmitting data signals and a control channel for transmitting control signals are individually installed, and more particularly to a transmission device which notifies a failure of a data channel to other transmission devices and specifies the location of failure. The present invention also relates to a transmission network system having such transmission devices.

2. Description of the Related Art

An optical transmission device is used mainly for carrier networks and backbone networks, so it is important for the optical transmission device to keep on transmitting data signals even if failure occurs. For this, in an optical transmission network system comprised of optical transmission devices, an advanced failure detection mechanism and a duplicated mechanism are installed. A SONET/SDH system, for example, has a data signal redundant scheme, such as 1+1, 1:N, UPSR (Uni-Directional Path Switched Ring), or BLSR (Bi-Directional Line Switched Ring) in order to guarantee the availability of data signals.

The network configuration of a SONET/SDH system, however, is limited to a connection format where the optical transmission devices are connected in a series (linear) or ring, so flexibility in network configuration is low. Therefore research is progressing to use a network having a mesh type connection format, which is used for data system networks and has high flexibility, for a carrier network and backbone network as well.

Also recently, optical transmission network systems, where light signals with single wavelength which were time division multiplexed by a SONET/SDH system are modulated and light signals with a plurality of different wavelengths are wavelength Division Multiplexed (WDM: Wavelength Division Multiplex) for transmission, are becoming popular.

In such an optical transmission network system, a transmission device called an optical edge (OADX) node, which locates at the boundary between SONET/SDH technology and WDM technology, and a transmission device called an optical cross-connect (OXC) node (or optical core node), which switches light signals as is within the WDM area, are installed. In the case of the OADX node which converts light signals into electric signals for switching, a delay occurs within the node, but in the case of the OXC node which switches light signals as is, a delay due to conversion into electric signals does not occur, and hardware for electric conversion and terminating processing is not required. Therefore the OXC node has an advantage over the OADX node in terms of device cost.

The scale of networks, on the other hand, is dramatically expanding as data traffic increases due to the spread of the Internet. Because of this, GMPLS (Generalized Multi-Protocol Label Switching) technology, which allows provision all nodes at once per path basis by signaling, is attracting attention, instead of provisioning a cross-connect for each node using a maintenance command such as TL-1 command.

The GMPLS technology is also applied to the carrier network expanding management protocol of the IP network of a data system, where maintenance efficiency is improved by integrating the setting and maintenance of paths with the IP network. Each node operates with intelligence so that a protection path, used when failure occurs, is automatically set by signaling. Therefore the burden on network management, which once required centralized management, can be dramatically decreased.

In the case of an optical transmission network system comprised of optical transmission devices, OXC nodes in particular, a data channel for transmitting the data signals (data channel signals) are cross-connected (switched) as light at the OXC node, so the data signals and control signals cannot be superimposed or separated by optical signals with a same wavelength. Therefore in the optical transmission network system, a data channel for transmitting data signals is separated from a control channel for transmitting control signals. For a method of separation, a method for assigning a control channel to one of a plurality of wavelength division multiplexed wavelengths and separating the data channel and control channel depending on the difference of the wavelengths within one optical fiber, and a method for installing an optical fiber for transmitting a data channel and an optical fiber for transmitting a control channel separately have been proposed in a draft of the IETF (Internet Engineering Task Force).

A control channel is always provided between nodes where a data channel exists, and is statically associated with the data channel. This control channel carries signals for routing protocol, signaling protocol for GMPLS, notification of failure information, and so on.

When a failure occurs to a data channel, for example, the failure information is notified between the OXC nodes by the control channel using the link management protocol (LMP), which is stated in a draft of the IETF, and the location of the failure is discovered.

For example, when a failure occurs to a data channel between the OXC nodes N2 and N3 in the optical transmission network system shown in FIG. 19, the message shown in FIG. 20 is communicated between the nodes via a control channel, and the failure location is discovered. In other words, when a failure occurs to a data channel, all the nodes at the downstream side of the failure location (nodes N3 and N4 in FIG. 19) detect the loss of light (LOL). The nodes N3 and N4, which detected LOL, transmit the ChannelFail message to the nodes N2 and N3 in the previous stage respectively via the control channel.

The nodes N2 and N3, which received the ChannelFail message, check the input port of the optical path, and confirm whether LOL is detected. In the input port of the node N2, LOL is not detected, but in the input port of the node N3, LOL is detected. The node N2, where LOL is not detected in the input port, judges that failure occurred between the node N2 and the adjacent node N3 at the downstream side, and replies with the ChannelFailNack message to the node N3. The node N3, where LOL is detected in the input port, on the other hand, replies with the ChannelFailAck message, notifying that the N3 node itself also detected LOL, to the adjacent node N4 at the downstream side. In this way the failure location is discovered to the section between the nodes N2 and N3.

After the failure location is discovered, the node N2 starts setting a bypass route (protection path) of the data channel (switching optical path) to save the data signals.

With the current method for discovering the failure location by LMP, however, discovering the failure location and saving the data signals (recovery of optical path) are possible when failure occurs only to a data channel, but when a failure occurs to a control channel or node, the failure location cannot be discovered, and as a result the data signals cannot be saved.

A possible method to solve this is to centralize control of the entire network using a network management system (NMS), so as to monitor the failure of a control channel or the failure of a node. With this method, however, at least several seconds of time is required for discovering the failure location and processing protection switching, which makes it impossible to satisfy the completion of saving processing within 50 ms, which is generally required for a transmission device.

Another possible method is duplicating the control channel. With this method, however, the failure location still cannot be discovered and the data signals cannot be saved when a node failure occurs, and the network resource for the control channel must always be duplicated, which increases cost.

### SUMMARY OF THE INVENTION

It is an object of the present invention to provide a transmission device and a transmission network system which can satisfy a failure location even if a failure occurs to a transmission device or a control channel.

A transmission device according to a first aspect of the present invention is a transmission device in a transmission network system having a plurality of transmission devices and providing a data channel for transmitting data signals and a control channel for transmitting control signals in separate optical fibers or physical links between the transmission devices, said data signals being transmitted along a preset path, comprising: a first failure detecting unit for detecting a failure of a working control channel which transmits control signals for controlling a working data channel for transmitting data signals to be input along a working path set at its transmission device from a transmission device adjacent to an upstream side on said working path; a second failure detecting unit for detecting a failure of said working data channel; a route searching unit for searching a route of a protection control channel for the working control channel, in which a failure is detected by said first failure detecting unit, between its transmission device and a transmission device located at the upstream side on said working path; and a transmission unit for transmitting information on the failure detected by said second failure detecting unit to said transmission device located at the upstream side by the protection control channel along the route searched by said route searching unit.

Here “a failure of a working data channel” includes a failure which occurred to the working data channel itself, a failure which occurred to the working data channel due to failure of another working channel located at the upstream side of the working data channel on the working path, and failure which occurred due to the failure of a transmission device located at the upstream side of the working control channel on the working path. And “failure of working control channel” includes failure which occurred to the current control channel itself, and failure which occurred to the working control channel due to failure of a transmission device located at the upstream side of the working control channel.

According to the first aspect of the present invention, a path of the protection control channel is searched even if a failure occurred to the working control channel, and control signals are sent by the protection control channel. By this, a failure detected in the working data channel is notified to the transmission device at the upstream side. And by this failure notification, the failure location can be discovered.

A transmission device according to a second aspect of the present invention is a transmission device in a transmission network system having a plurality of transmission devices and providing a data channel for transmitting data signals and a control channel for transmitting control signals individually between the transmission devices, said data signals being transmitted along a preset path, comprising: a reception unit for receiving information on a failure of a working data channel, said information on the failure being sent from a transmission device located on a downstream side on a working path set at its transmission device via a protection control channel for a working control channel of said transmission device located on the downstream side; a failure detecting unit for detecting a failure of the working data channel for transmitting data signals to be input along said working path; and a judgment unit for judging an occurrence location of the failure based on positional relationship between its transmission device and said transmission device positioned at the downstream side, and presence of failure detected by said failure detecting unit.

According to the second aspect of the present invention as well, the location of the failure can be discovered.

A transmission device according to a third aspect of the present invention is a transmission device in a transmission network system having a plurality of transmission devices and providing a data channel for transmitting data signals and a control channel for transmitting control signals individually between the transmission devices, said data signals being transmitted along a preset path, comprising: a reception unit for receiving information on failure of a working data channel for transmitting data signals to be input to a first transmission device along a working path, said first transmission device being located at a downstream side of said work path, said information on failure being transmitted from said first transmission device to a second transmission device located at an upstream side of said working path via a protection control channel for a working control channel of said first and second transmission device, said working control channel being provided along said working path; and a transmission unit for transmitting said information on failure received by said reception unit via said protection control channel so that said information is received by said second transmission device.

A transmission network system according to a fourth aspect of the present invention is a transmission network system having a plurality of transmission devices and providing a data channel for transmitting data signals and a control channel for transmitting control signals individually between the transmission devices, said data signals being transmitted along a preset path, comprising: a first transmission device located at a downstream side of a working path being set; a second transmission device located at an upstream side of said working path being set; and a third transmission device for relaying information communicated between said first transmission device and said second transmission device, wherein said first transmission device comprises: a first failure detecting unit for detecting a failure of a working control channel which transmits control signals for controlling a first working data channel, said first working data channel transmitting data signals to be input from a transmission device adjacent to an upstream side on said working path along said working path; a second failure detecting unit for detecting a failure of said first working data channel; a route searching unit for searching a route of a protection control channel of the working control channel where a failure is detected by said first failure detecting unit between said first transmission device and said second transmission device; and a first transmission unit for transmitting information on the failure detected by said second failure detecting unit to said second transmission device by a protection control channel along the route searched by said route searching unit, said third transmission device comprises: a first reception unit for receiving said information transmitted by said first transmission unit via said protection control channel when said third transmission device positions on the route searched by said route searching unit; and a second transmission unit for transmitting said information via said protection control channel so that said information received by said reception unit is received by said second transmission device, and said second transmission device further comprises: a second reception unit for receiving said information transmitted from said first transmission device via said second transmission device; a third failure detecting unit for detecting a failure of a second working data channel for transmitting data signal to be input along said working path; and a judgment unit for judging said failure location based on positional relationship between said second transmission device and said first transmission device, and based on presence of the failure detected by said third failure detecting unit.

According to the fourth aspect of the present invention as well, a functional effect similar to the first aspect can be obtained.

### BRIEF DESCRIPTION OF THE DRAWINGS

FIG. 1 is a block diagram depicting a configuration example of an optical transmission network system according to the first embodiment of the present invention;

FIG. 2 is a block diagram depicting a configuration of the nodes N1 to N6 respectively;

FIG. 3 shows the detailed setting content of the optical path #a;

FIG. 4 shows the bypass route setting for a control channel when a failure occurs to the control channel C23 and data channel A-2 of the node N3 of the communication network system 1;

FIG. 5 is a diagram depicting the sequence of the connection establishment processing of the optical path #a;

FIGS. 6A, 6B and 6C show the messages prescribed by RSVP-TE;

FIG. 7 shows the configuration of the optical path management data on the optical path #a held by the signaling controlling unit of the node N3;

FIG. 8 shows a configuration example of the control channel management data on CCID “A” of the node N3;

FIG. 9 shows a configuration example of the data channel management data;

FIG. 10 shows a configuration example of the optical cross-connect data;

FIG. 11A shows a configuration example of the bypass ChannelFail message;

FIG. 11B shows a configuration example of the bypass ChannelFailAck message;

FIG. 11C shows a configuration example of the bypass ChannelFailNack message;

FIG. 12 is a flow chart depicting the processing flow of the LMP controlling unit when a failure occurs to a data channel in a state where a failure occurred to the control channel;

FIG. 13 is a flow chart depicting the detailed processing flow of the bypass route deciding processing in Step S7 in FIG. 12;

FIG. 14 is a flow chart depicting the processing flow of the LMP controlling unit of the node which received the bypass ChannelFail message;

FIG. 15 shows how to set the bypass route of the control channel C23 of the optical transmission network system 1;

FIG. 16 is a flow chart depicting the processing flow of the LMP controlling unit;

FIG. 17A shows a configuration example of the bypass Path message;

FIG. 17B shows a configuration example of the bypass Resv message;

FIG. 17C shows a configuration example of the PathErr message;

FIG. 18 is a flow chart depicting the processing flow of the termination node (destination node);

FIG. 19 is a block diagram showing an optical transmission system used to explain the conventional processing for discovering a failure location;

FIG. 20 is a sequence diagram showing flow of the processing for discovering a failure location according to the conventional LMP.

### DESCRIPTION OF THE PREFERRED EMBODIMENTS

### First Embodiment

System Configuration

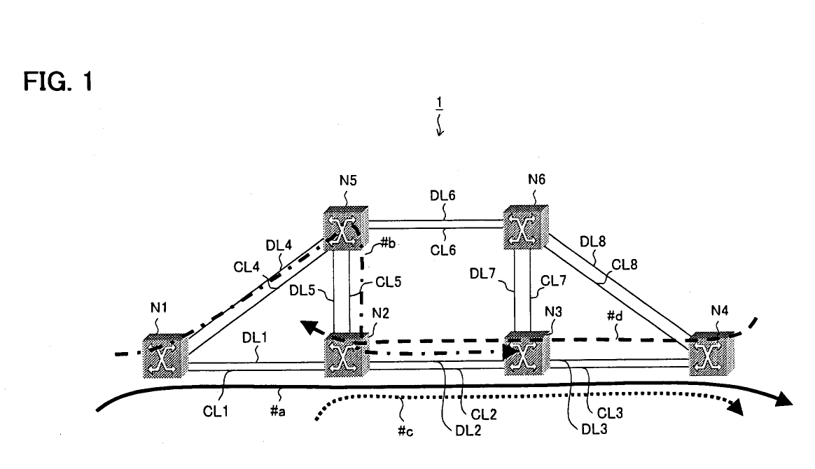

FIG. 1 is a block diagram depicting a configuration example of an optical transmission network system 1 according to the first embodiment of the present invention. This optical transmission network system 1 has optical cross-connect (OXC) nodes (hereafter simply called “nodes”) N1 to N6 as an example of transmission devices, and optical fiber links DL1 to DL8 for data channels, and optical fiber links CL1 to CL8 for control channels, which connect these nodes N1 to N6.

As FIG. 1 shows, the optical transmission network system 1 has no formats where each node is connected in a ring or straight line (linear), but has a mesh type connection format where the ring and linear formats are combined. In the present embodiment, the optical transmission network system 1 manages the connection status between nodes using LMP (Link Management Protocol) specified in GMPLS (Generalized Multi-Protocol Label Switching).

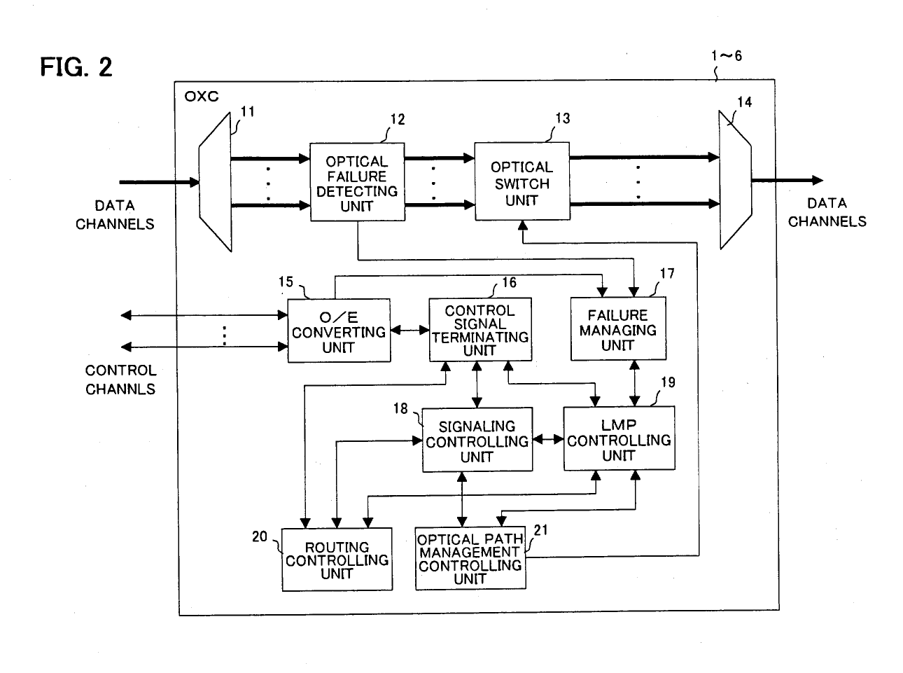

The nodes N1 to N6 all have the same configuration. FIG. 2 is a block diagram depicting a configuration of the nodes N1 to N6 respectively. Each of the nodes N1 to N6 has a demultiplexer 11, optical failure detecting unit 12, optical switch unit 13, multiplexer 14, O/E converting unit 15, control signal terminating unit 16, failure managing unit 17, signaling controlling unit 18, LMP controlling unit 19, routing controlling unit 20, and optical path management controlling unit 21.

n number of (n is 2 or more integer) wavelength division multiplexed (WDM) optical signals with wavelengths λ1 to λn (n channels of data channel signals) are input to the demultiplexer 11 from the adjacent node at the upstream side via the optical fiber link for data channels for reception (downstream). In the node N3, for example, the optical signals which were sent to the node N3 via the optical fiber for reception of the optical fiber links for data channels DL2, DL3 and DL7 are input to the demultiplexer 11. Optical signals with one wavelength correspond to one channel of the data channel signals. The demultiplexer 11 demultiplexes the input optical signals into each wavelength (for each channel), and sends the demultiplexed n channels of data channel signals to the optical failure detecting unit 12.

The optical failure detecting unit 12 monitors the occurrence of failure in n number of data channel signals sent from the demultiplexer 11 for each wavelength (for each channel), and if a failure is detected, the optical failure detecting unit 12 notifies the identifier (later mentioned data channel ID or interface ID) of the failed data channel, to the failure managing unit 17. Failures include LOL (loss of light) where the energy (or intensity) of the optical signal becomes lower than a predetermined level. LOL may occur when only a certain ë data channel signal of a specific channel attenuates, or when the optical fiber itself is disconnected, and in such a case LOL may occur to all the data channel signals to be transmitted by that optical fiber.

The optical switch unit 13 switches the n channels of data channel signals demultiplexed by the demultiplexer 11 remaining as optical signals based on the optical cross-connect data (switching data) set by the optical path management controlling unit 21, and outputs the switched n channels of data channel signals to the multiplexer 14. The optical cross-connect data will be described later.

The multiplexer 14 wavelength-division-multiplexes the n channels of data channel signals, and outputs the optical signals to the adjacent node at the downstream side. The multiplexer 14 of the node N3, for example, transmits the optical signals to the nodes N2, N6 and N4. In FIG. 2, only one optical fiber is shown for input and output respectively to simplify the drawing, but in the node N3 in FIG. 1, for example, three optical fibers exist for input and output respectively.

The control channel signals transmitted from the adjacent node at the upstream side are input to the O/E converting unit 15 as optical signals. In the node N3, for example, the optical signals transmitted to the node N3 are input to the O/E converting unit 15 via the optical fiber for reception of the optical fiber links CL2, CL3 and CL7 for control channels. The O/E converting unit 15 converts the optical signals which were input into electric signals, and sends these control channel signals as electric signals to the control signal terminating unit 16. The O/E converting unit 15 converts the control channel signals as electric signals sent from the control signal terminating unit 16 into optical signals, and sends the control channel signals as optical signals to the adjacent node at the downstream side. The O/E converting unit 15 of the node N3, for example, sends the optical signals to the nodes N2, N6 and N4.

The O/E converting unit 15 monitors the occurrence of failure in the control channel, and if a failure is detected, the O/E converting unit 15 notifies the failed control channel to the failure managing unit 17.

The control signal terminating unit 16 terminates the control channel signals. The failure managing unit 17 notifies the failure notified from the optical failure detecting unit 12 or O/E converting unit 15 to the LMP controlling unit 19.

The LMP controlling unit 19 terminates the LMP (Link Management Protocol). The LMP controlling unit 19 holds the control channel management data, and using this control channel management data, the LMP controlling unit 19 (1) associates the later mentioned interface IDs (channel management numbers) to wavelengths which are used between adjacent nodes, (2) discovers the failure location of the data channel, (3) maintains and monitors the control channel, and (4) tests the data channel. The control channel management data will be described in detail later.

In the present embodiment, when a failure is detected in a data channel and control channel, the LMP controlling unit 19 requests the routing controlling unit 20 to search the shortest route that can bypass the failed node or failed channel. And the LMP controlling unit 19 uses the searched shortest route as an alternate route (protection path) of the control channel that cannot be used due to failure, and notifies failure using the route. This processing will be described in detail later.

The routing controlling unit 20 terminates the routing protocol (e.g. OSPF (Open Shortest Path First)), and determines a route to the destination node based on the topology information being held. Also according to the present embodiment, the routing controlling unit 20 determines the shortest route which bypasses the failed node or failed channel by a request from the LMP controlling unit 19, and transmits new topology information using LSA (Link State Advertisement) when the failure of the control channel is detected.

The signaling controlling unit 18 terminates the signaling protocol (e.g. RSVP (Resource Reservation Protocol), RSVP-TE (Resource Reservation Protocol-Traffic Engineering), etc.), and sets an optical path to the destination node. The optical path includes a working path and a protection path or bypassing path. The signaling controlling unit 18 sets an optical path for protection (protection path) which bypasses the failed location, controlling the pass setting message, including failure notification, by a request from the LMP controlling unit 20, and controls such that label merging to return from the working optical path before failure occurred, to the working optical path via the bypass path (protection path) which is set after failure occurs.

The signaling controlling unit 18 holds optical,path management data. The optical path management data includes such data as optical path route data, bypass control channel management data, etc. These data will be described in detail later.

The optical path management controlling unit 21 manages the optical cross-connect data, which indicate the association between the input wavelengths of the optical fiber links for input and the output wavelengths of the optical fiber link for output. Also the optical path management controlling unit 21 sets the optical switch unit 13. According to the present embodiment, the optical path management controlling unit 21 associates the optical cross-connect data of the bypass optical path (protection path) for bypassing the failed location with the original working optical path (working path), and executes label merge (combining labels used for GMPLS).

In the following description, when a distinction is made among the component units 11 to 21 shown in FIG. 2 depending on the node, “Ni”, of the node Ni (i=1 to 6) is added as a suffix after the symbol of the component unit. For example, the LMP controlling unit 19 of the node N3 is denoted as “LMP controlling unit 19_{N3}”, and the LMP controlling unit 19 of node N2 is denoted as “LMP controlling unit 19_{N2}”. If a suffix is not added, this means that the component unit is that of an arbitrary node.

Optical Path Setting Processing

In the optical transmission network system 1, an optical path (LSP (Label Switch Path) in the case of GMPLS), determining the route of the data channel signals which are input from the input end (input optical edge) and output from the output end (output optical edge), is set. Data channel signals are communicated along the optical path.

In the present embodiment, four optical paths (working optical paths) #a to #d are set, for example, as shown in FIG. 1. The optical path #a is a path from the node N1 to the node N4 via the nodes N2 and N3. The optical path #b is a path from the node N1 to node N3 via the nodes N5 and N2. The optical path #c is a path from the node N2 to node N4 via the node N3. And optical path #d is a path from the node N4 to node N2 via the node N3.

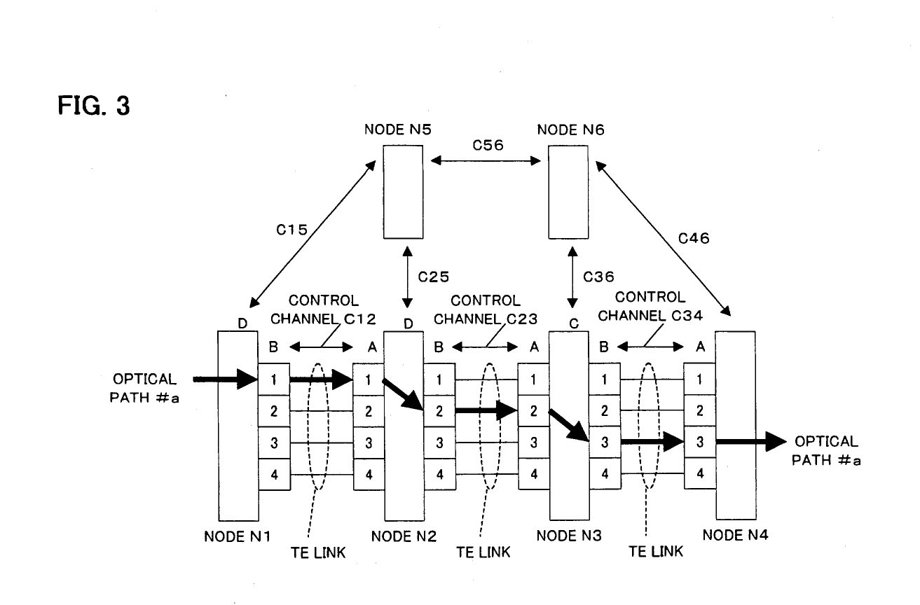

Using the optical path #a as an example, path setting processing for the optical path #a will now be described. FIG. 3 shows the detailed setting content of the optical path #a.

To make description simpler, in the present embodiment, it is assumed that four channels of data channels are installed respectively between the output port B of the node N1 and the input port A of the node N2, between the output port B of the node N2 and the input port A of the node N3, and the output port B of the node N3 and the input port A of the node N4. One control channel signal is assigned to these four channels of data channel signals.

For the path setting processing, RSVP-TE, which is one of the signaling protocols used for GMPLS, is used.

At first, the terms used for path setting processing by RSVP-TE and the later mentioned bypass path setting processing when failure occurs will be described, then path setting processing by RSVP-TE will be described.

“Node identifier (node ID)”: This is an identifier for uniquely identifying the nodes N1-N6 in the optical transmission network system 1. For routing and signaling, a representative IP address is used as the node ID. Here “N1” to “N6” are used as the node ID of each node.

“LSP-ID”: This is the same as an optical path identifier (optical path ID), and is an identifier of LSP which is assigned to each optical path at path setting by signaling. The LSP-ID is unique within each node N1 to N6, and is also a unique value (a value when the Ingress Edge Node ID and unique ID in Edge Node are combined is used) in the optical transmission network system 1. Here “#a” to “#d” are used as an LSP-ID.

“Control channel identifier (CCID)”: This is an identifier to be assigned to the control channel, and is a unique value only within each node. Here the above mentioned input port identifier A or output port identifier B are used as a CCID.

If the control channel between the node Ni and node Nj (i and j have a value of one of 1 to 6) is “Cij” in FIG. 3 for example, then the CCID in the node N2 of the control channel C12 between the nodes N1 and N2 becomes “A”, and the CCID in the node N1 becomes “B”. The CCID in the node N3 of the control channel C23 becomes “A”, and the CCID in the node N2 becomes “B”. The CCID in the node N3 of the control channel C36 becomes “C”. Since a CCID is unique only within a node, the same CCID may be assigned in different nodes.

“Interface identifier (Interface ID)”: This is the same as the data channel identifier (data channel ID), which is an identifier to be assigned to a data channel, and is a value which uniquely identifies a wavelength (channel) of a port within a node. A symbol, when a port identifier such as “A” and “B” and a wavelength identifier (component ID) indicated by the symbols “1” to “4” are combined, such as “A-1” and “B-2”, are used as an interface ID. Since the interface ID is unique within a node, the same value may be used in different nodes.

“TE link identifier (TE link ID)”: This is an identifier of TE (Traffic Engineering) link which is a data channel group managed by one control channel, and the same value as the CCID is used in the present embodiment.

“Optical wavelength label”: This is a label used for GMPLS, and the same value as the interface ID is used in the present embodiment. Therefore an optical wavelength label consists of a set of port identifier and wavelength (e.g. “A-1”).

“Control channel management data”: This is data for managing the state of the control channel, and is held by the LMP controlling unit 19. This control channel management data is also data for indexing CCIDs, which manages the interfaces, from the input interface IDs. This control channel management data is generated by registering the control channel by a command, or is automatically generated when the nodes are connected by a connection channel and the nodes communicate and exchange information with each other.

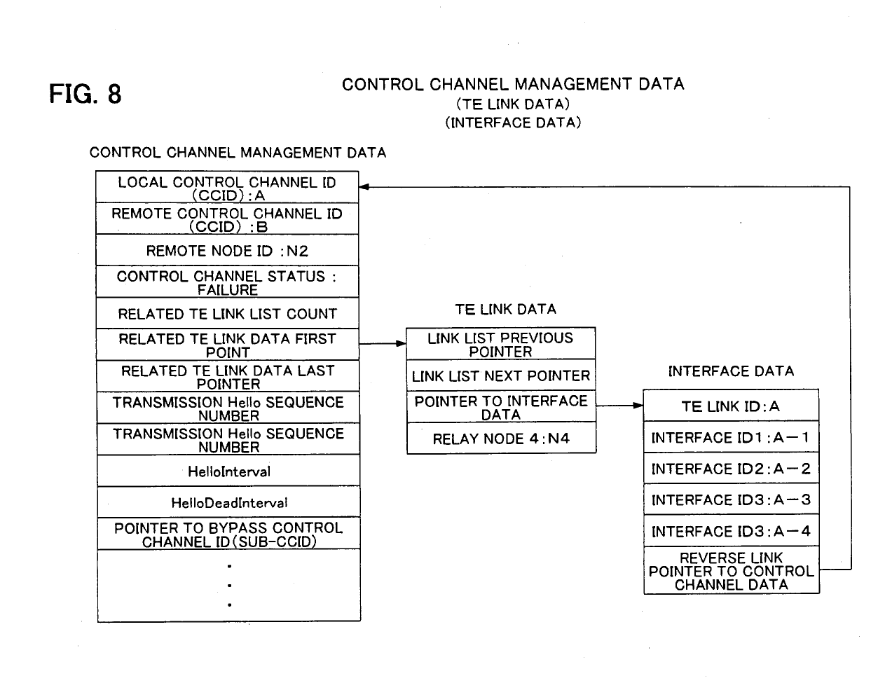

FIG. 8 shows a configuration example of the control channel management data on CCID “A” of the node N3. The control channel management data has a local control channel ID, remote control channel ID, remote node ID, control channel status, and related TE link data first pointer.

The “local control channel ID” indicates the CCID of the control channel in the local node. The control channel management data in FIG. 8 is the control channel data for CCID “A” in the node N3, so the local control channel ID is “A”.

The “remote control channel ID” indicates the CCID of the control channel in an adjacent node connected to the control channel with the local control channel ID. For example, the control channel with CCID “B” of the node N2 is connected to the control channel with CCID “A” of the node N3, so the local control channel ID is “B”.

The “control channel status” indicates the status of the control channel with the local control channel ID. In the area of “control channel status”, a value indicating “normal” is written if the control channel is normal, and a value indicating “failure” is written if failure is detected in the control channel.

The “number of related TE link lists” indicates the number of lists of the TE link (that is, the number of TE links) managed by this control channel.

The “related TE link data first pointer” is a pointer indicating the data of the TE link (TE link data) managed by this control channel. If one control channel manages a plurality of TE links, a plurality of TE link data are set, and in this case, the related TE link data first pointer indicates the first one of the plurality of TE link data.

TE link data has a pointer to the interface data. The interface data has a pointer to indicate the TE link ID of the TE link managed by this control channel, interface ID and control channel management data.

The control channel management data is set for each control channel, and is searched by the CCID. In the case of the node N3, for example, in addition to the control channel management data on the control channel ID “A” in FIG. 8, control channel management data on the control channel ID “B” and “C” are also set respectively, which are searched by the CCIDs “B” and “C”. This is the same for the other nodes as well.

Now the optical path #a setting processing will be described. The optical path #a is a path passing through the interface (data channel) B-1 of the node N1 to the interface A-1 of the node N2, the interface B-2 to the node N2 to the interface A-2 of the node N3, and the interface B-3 of the node N3 to the interface A-3 of the node N4. The optical switch unit 13 of the nodes N1 to N4 respectively executes optical switching (optical cross-connect) so that the input side interface and the output side interface of each node are connected.

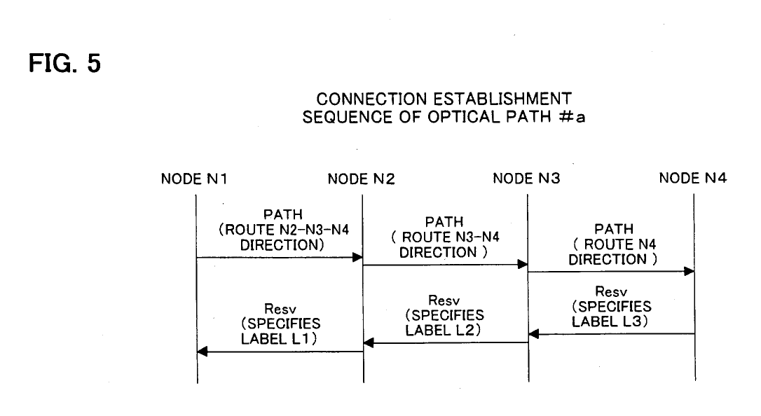

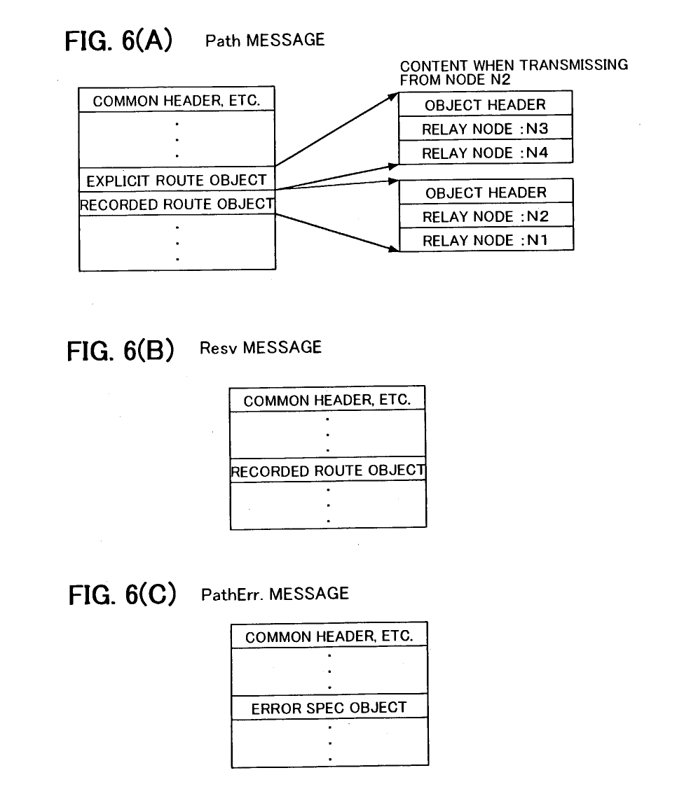

To set the optical path #a, the Path message and Resv message (and PathErr message) prescribed in RSVP-TE are communicated among the nodes N1 to N4. FIG. 5 is a diagram depicting the sequence of the connection establishment processing of the optical path #a. FIGS. 6A to 6C show the messages prescribed by RSVP-TE, where FIG. 6A shows the configuration of the Path message, FIG. 6B shows the configuration of the Resv message, and FIG. 6C shows the configuration of the PathErr message respectively.

Signaling from the node N1 to node N4 is started by GMPLS. In other words, the Path message is transmitted from the node N1 to the node N4 via the control channel according to the Explicit Route Object information.

In the Explicit Route Object, information on a node string (in this case nodes N1 to N4) (string of node IDs) where the signals will pass through is stored. The Path message is sent from the node which is at the first position of Explicit Route Object. And each time a node is passed, node information is popped and deleted one by one from the first position of this area. Hereby, the Path message is sequentially sent along the node string specified in Explicit Route Object. FIG. 6A, for example, shows the content of the Explicit Route Object of the Path message which is sent from the node N2 to node N3.

The Recorded Route Object stores information on nodes which signals already passed through. Each time a node is passed through, information on the passed node is pushed into this area one by one. FIG. 6A, for example, shows the content of the Recorded Route Object of the Path message which is sent from the node N2 to node N3.

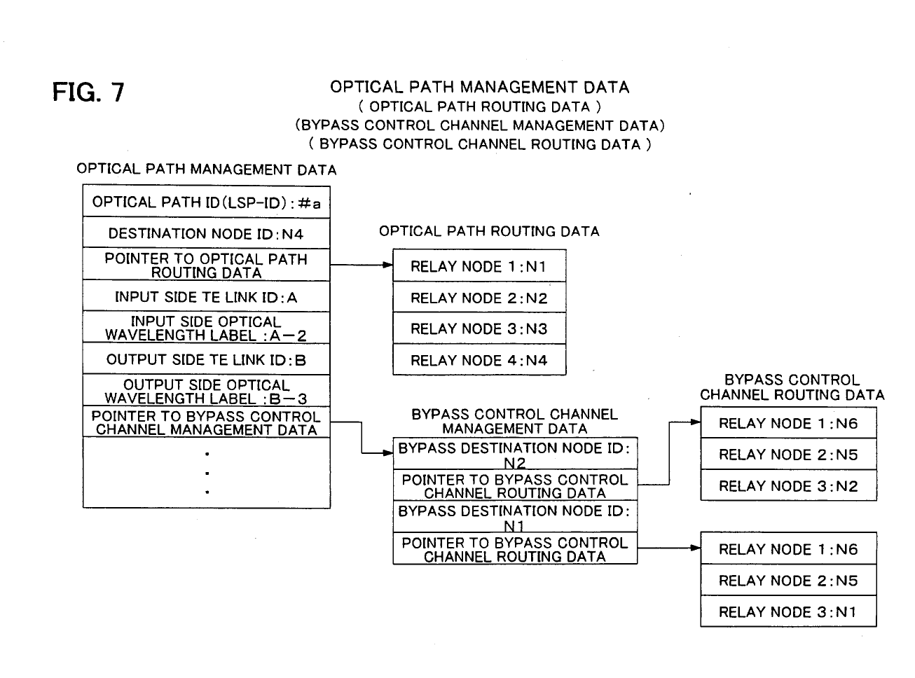

The signaling controlling unit 18 of the node which received the Path message judges whether the resource (bandwidth) of the data channel is available, and if the resource is available, the signaling controlling unit 18 reserves the resource and generates the optical path management data. FIG. 7 shows the configuration of the optical path management data on the optical path #a held by the signaling controlling unit 18_{N3} of the node N3.

The optical path management data has the optical path ID, destination node (Egress Node) ID, pointer to the optical path routing data, input side TE link ID, input side optical wavelength label, outside TE resource ID, output side optical wavelength label, and pointer to the bypass control channel management data.

Since the optical path management data is on the optical path #a, the value of the “optical path ID” is “#a”. “Destination node” refers to the destination node on the optical path #a of the node holding the optical path management data (in this case node N3), and is the node N4 in this case.

The “pointer to optical path routing data” is a pointer (e.g. address of memory) to indicate the optical path routing data storage location. The optical path routing data indicated by this pointer is the combination of the node information on the Explicit Route Object and the node information on the Recorded Route Object, therefore [this data] has information on the node string of the optical path #a (node IDs of nodes N1 to N4).

The “input side TE link ID” holds the input side TE link ID “A” to the node N3, and the “input side optical wavelength label” holds the input side optical wavelength label “A-2” to the node N3. The “output side TE link ID” holds the output side TE link ID “B” from the node N3, and the “output side optical wavelength label” holds the output side optical wavelength label “B-3” from the node N3.

The “Pointer to bypass control channel management data” is a pointer (e.g. address of memory) to indicate the bypass control channel management data storage location. The “bypass control channel management data” and the “bypass control channel routing data” indicated by the bypass control management data will be described later.

The optical path management data is set for each optical path. In node N3, for example, in addition to the optical path #a, the optical paths #b to #d are also set, so the optical path management data for these optical paths are also set. Each optical path management data is searched by the LSP-ID (optical path ID).

After reserving the resource, the signaling controlling unit 18 generates the Path message to the node which exists at the downstream side of the data channel where the resource is reserved, and transmits the Path message.

If the node which received the Path message cannot reserve the resource, the PathErr message (FIG. 6C) is transmitted.

When the Path message is sent to the destination node N4, then the Resv message is sent back from the destination node N4 to the source node N1 via the control channel. And the resource reserved by the Path message is secured by the Resv message.

When the signaling controlling unit 18_{N3} of the node N3 receives the Resv message from the node N4, for example, the signaling controlling unit 18_{N3} requests the LMP controlling unit 19_{N3} to secure the output side optical wavelength label B-3 in the node N4 direction and to secure the input side optical wavelength label A-2 in the node N2 direction according to the optical path management data.

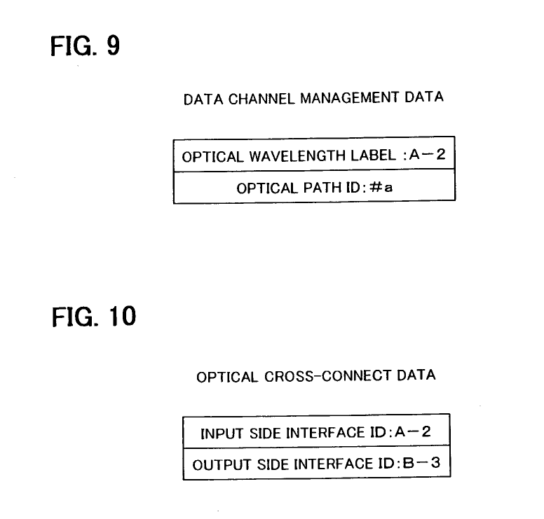

The LMP controlling unit 19_{N3} of the node N3 which received the request determines the output side interface B-3, and adds one optical wavelength label and the interface A-2 from the input side available resources, so as to generate data channel management data (see FIG. 9) for associating the optical wavelength label A-2 and the optical path ID (LSP-ID) #a.

The optical path management controlling unit 21_{N3} of the node N3 generates the optical cross-connect data (see FIG. 10) from the interface A-2 to the interface B-3, and sets the optical cross-connect of the optical switch unit 13 based on this data. Both the data channel management data and the optical cross-connect data are set for each interface ID, and are searched based on the interface ID.

Then the signaling controlling unit 18_{N3} sends the Resv message to the next node, node N2. Hereafter such processing of the signaling controlling unit 18, LMP controlling unit 19, and optical path management controlling unit 21 are executed in each node, and data channels between the nodes N1 to N4 are connected as the optical path #a.

For the optical paths #b-#d as well, optical paths are set by similar signaling.

Bypass Route for Control Channel Setting Processing When Failure Occurs

The setting processing of the bypass route (route of the protection control channel) for a control channel (working control channel) will now be described using an example when a failure (control channel failure, data channel failure, node failure) occurs on the optical path #a.

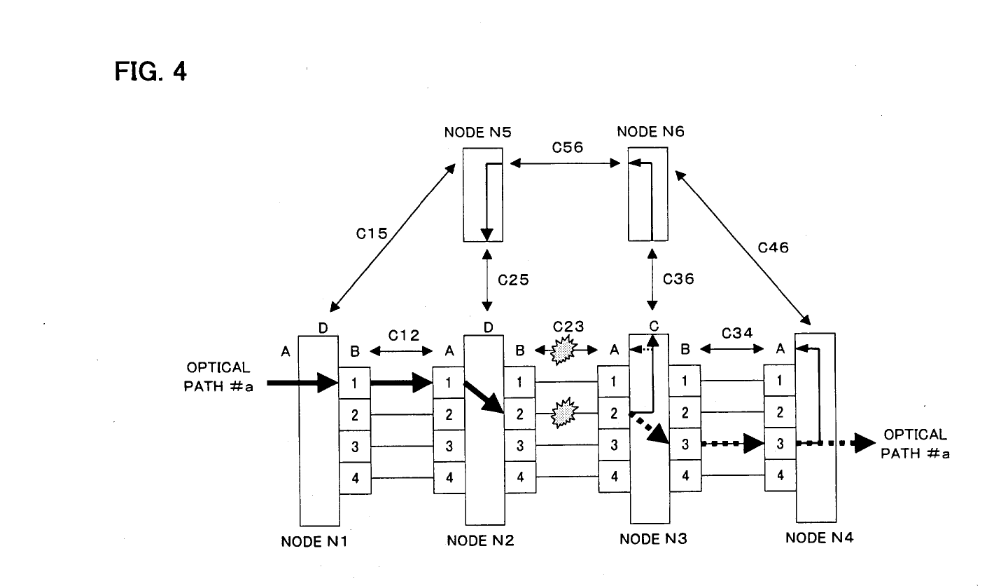

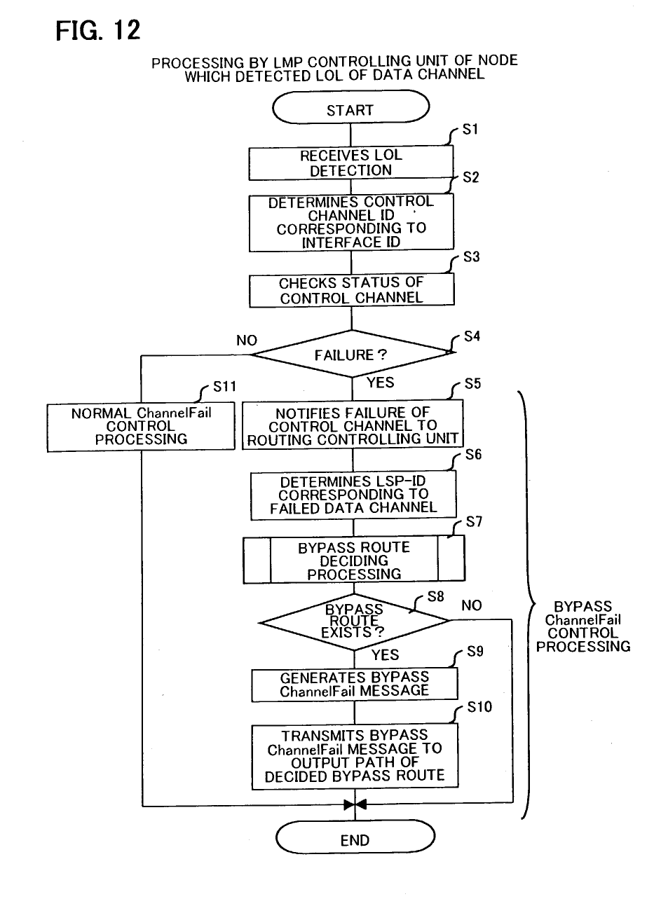

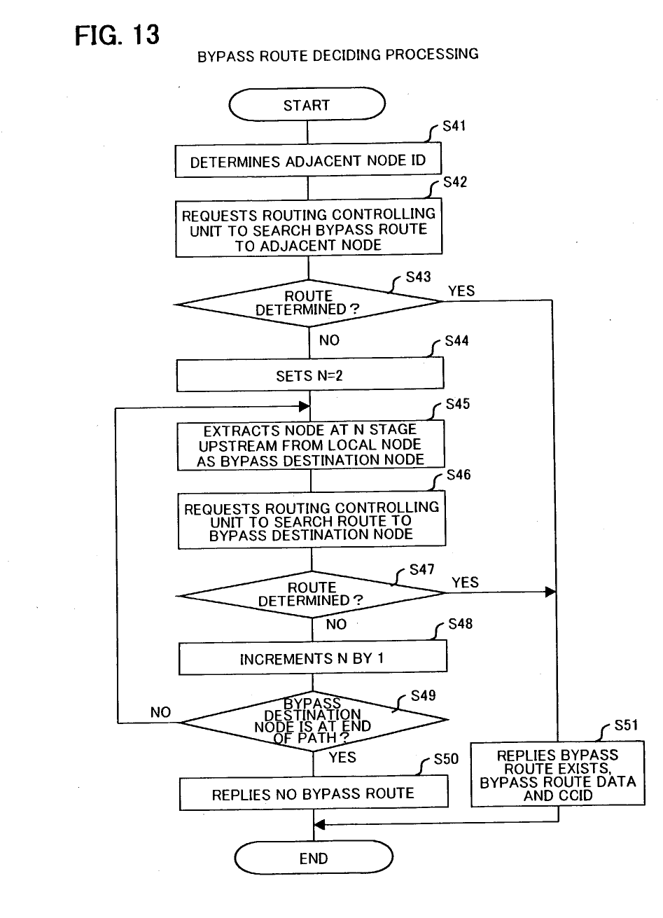

FIG. 4 shows the bypass route setting for a control channel when a failure occurs to the control channel C23 and data channel A-2 of the node N3 of the communication network system 1. FIG. 12 is a flow chart depicting the processing flow of the LMP controlling unit 19 when a failure occurs to a data channel in a state where a failure occurred to the control channel. And FIG. 13 is a flow chart depicting the detailed processing flow of the bypass route deciding processing in Step S7 in FIG. 12.

Bypass route determination processing by a node will now be described based on the failure example in FIG. 4.

When a failure occurs to the control channel (working control channel) C23, and the O/E converting unit 15_{N3} of the node N3 at the reception side (downstream side) of the control channel C23 detects the failure, the O/E converting unit 15_{N3} notifies the LMP controlling unit 19_{N3} about the failure of the control channel C23 (that is CCID “A” in node N3) via the failure managing unit 17_{N3}. Herewith, the LMP controlling unit 19_{N3} writes “Failure” to the control channel status of the control channel management data corresponding to CCID “A”.

If a failure occurs to the data channel (working data channel) A-2, which is one of the data channels managed by the control channel C23 (that is the data channel group of TE link ID “A”) while the control channel C23 (CCID “A”) is in failure, the optical failure detecting unit 12_{N3} of the reception side node N3 detects LOL of the interface A-2.

Hereby, the optical failure detecting unit 12_{N3} notifies the detection of failure of the interface A-2 to the LMP controlling unit 19_{N3} via the failure managing unit 17_{N3}. When the LMP controlling unit 19_{N3} receives the notification of the failure detection (S1 in FIG. 12), this notification triggers the start of failure location notification and discovering processing (S2 to S11 in FIG. 12).

At first, the LMP controlling unit 19_{N3} of the reception side node N3 determines the CCID “A” in the node N3, which corresponds to the failed interface (data channel) A-2, based on the control channel management data which the LMP controlling unit 19_{N3} holds itself (S2).

Then the LMP controlling unit 19_{N3} checks the status of the control channel of the determined CCID “A” with reference to the control channel management data (S3). When the status of the control channel is “Failure” (YES in S4), the LMP controlling unit 19_{N3} executes processing for bypassing the control channel (bypassing Channel Fail control processing (S5 to S10).

In other words, the LMP controlling unit 19_{N3} first notifies the failure of the control channel C23 to the routing controlling unit 20_{N3} (S5). By this, the routing controlling unit 20_{N3} changes the topology of the optical transmission network system 1 to the topology where the failed control channel C23 does not exist, and advertises the changes of the topology to the other nodes by LSA (Link State Advertisement).

Then the LMP controlling unit 19_{N3} provides the interface ID “A-2”, where failure occurred, to the signaling controlling unit 18_{N3}, and inquires the LSP-ID corresponding to the interface ID “A-2” to the signaling controlling unit 18_{N3} (S6). By this inquiry, the signaling controlling unit 18_{N3} returns the LSP-ID “#a” to the LMP controlling unit 19_{N3} based on the optical path management data being held.

Then the LMP controlling unit 19_{N3} makes the routing controlling unit 20_{N3} search another route (bypass route) to the node N2, which is the adjacent node at the upstream side (S7).

At first, the LMP controlling unit 19_{N3} determines the upstream side adjacent node ID “N2” by the remote node ID of the control channel management data of the failed control channel C23 (CCID “A”) (S41 in FIG. 13).

Then the LMP controlling unit 19_{N3} provides the adjacent node ID “N2” to the routing controlling unit 20_{N3}, and makes the routing controlling unit 20_{N3} search the bypass route to the node N2 (S43). For searching the bypass route, the Dijkstra algorithm of OSPF, for example, can be used. When the Dijkstra algorithm is used, the routing controlling unit 20_{N3} erases the link (route) directly connecting the local node N3 and the upstream side adjacent node N2 from the topology data, and determines the shortest route between the nodes N3 and N2 based on the topology data after the erase.

Hereby, the routing controlling unit 20_{N3} determines the bypass route from the node N3 to the node N2 via the nodes N6 and N5, for example, and determines “C” as the CCID of the output path corresponding to the bypass route (that is the output port C to the node N6).

When the bypass route is decided (YES in S43), the routing controlling unit 20_{N3} notifies the data to indicate the presence of a bypass route, bypass route data (node ID string of nodes N3, N6, N5 and N2), and CCID “C” to the LMP controlling unit 19_{N3} (S51).

Processing when Step S43 is NO, that is, when the routing controlling unit 20_{N3} cannot determine the bypass route to the node N2 or the searching result cannot be determined even if a predetermined time has elapsed, will be described later.

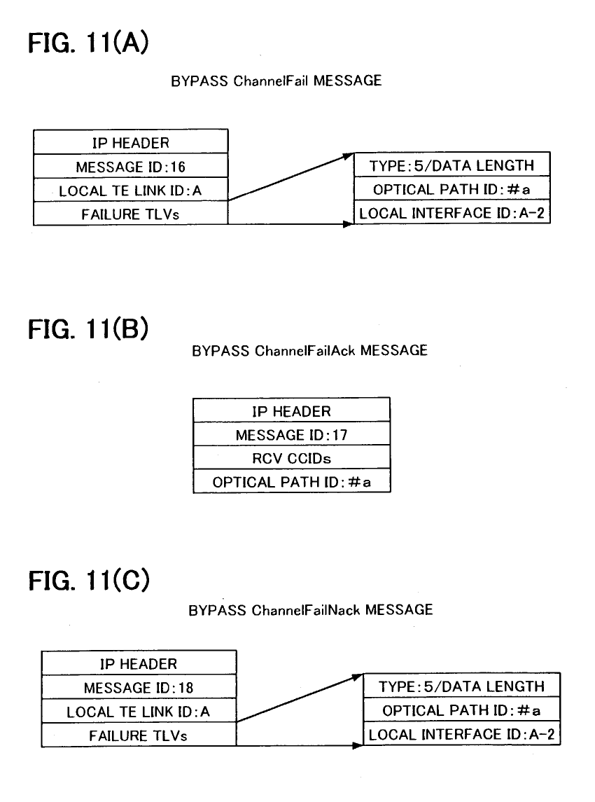

When a bypass route exists in FIG. 12 (YES in S8 in FIG. 12), the LMP controlling unit 19_{N3} generates the bypass ChannelFail message (S9). Since this bypass route ChannelFail message is sent along the control channels of the bypass route (that is protection control channels), the bypass route ChannelFail message is different from the normal ChannelFail message described for prior art. FIG. 11A shows a configuration example of the bypass ChannelFail message. The bypass ChannelFail message includes the local TE link ID and Failure TLVs in addition to the IP header. Failure TLVs include the optical path ID and local interface ID.

In the “local TE link ID”, the ID of the TE link having the failed data channel (TE link ID in node N3 in the failure generation example in FIG. 4) “A” is stored. In the optical path ID of Failure TLVs, the LSP-ID replied from the signaling control unit 18_{N3} in Step S8 (that is ID of the failed optical path) “#a” is stored. And in the local interface ID, the interface ID “A-2” in the node N3 where the failure was detected is stored.

The upstream side adjacent node N2 is stored in the column of the destination node of the IP header (not illustrated). And this bypass ChannelFail message is sent to the node N6 via the control channel C36 corresponding to the CCID “C” of the bypass route (S10).

Here a conventional LMP is based on the assumption that there is communication only between adjacent nodes, but according to the present embodiment, message communication by LMP is performed via a relay node. This is because (1) a bypass ChannelFail message is transmitted as an IP packet having an IP header (that is IP encoded), (2) each node has a function to execute such routing protocol as OSPF used for signaling and can perform IP routing of the bypass ChannelFail message, and (3) all the routing tables of the nodes N6 and N5 to the node N2 have been updated by LSA which was advertised from the node N3 to the other nodes in Step S5.

Therefore, the bypass ChannelFail message received by the node N6 is transferred to the destination node N2 via the nodes N6 and N5 so as not to pass through the link directly connecting the nodes N2 and N3. The bypass ChannelFail message is received at the node N2 from the control channel C25 (CCID “D” of node N2).

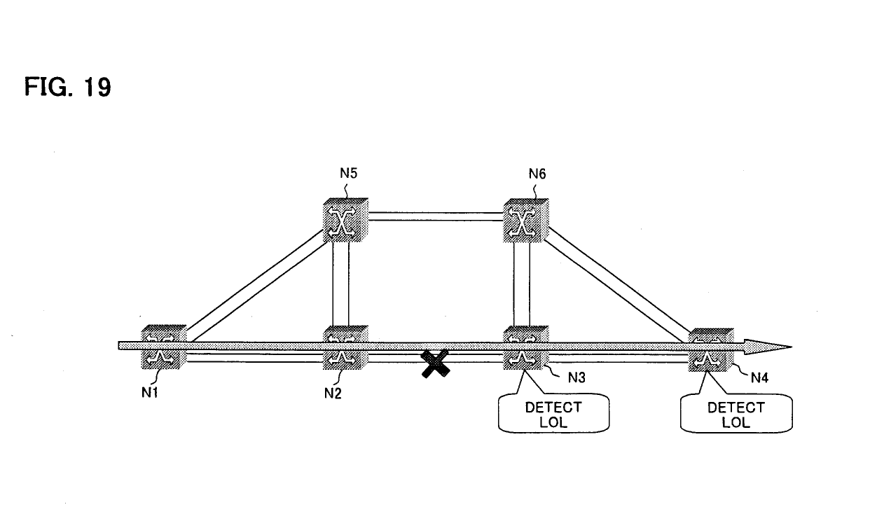

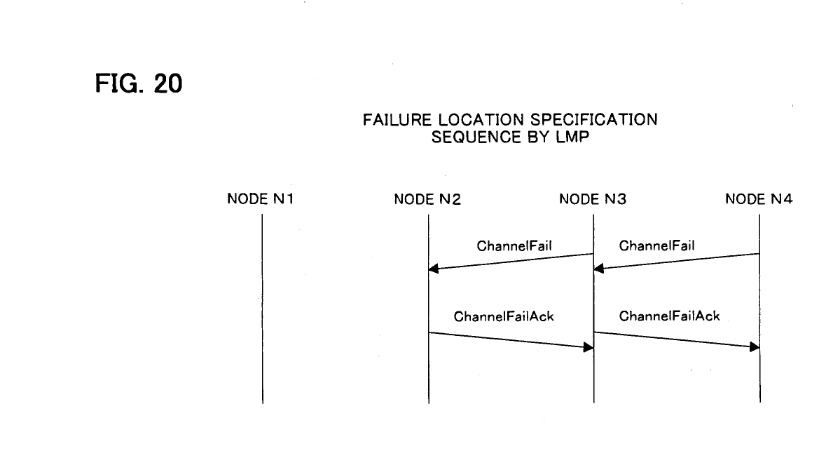

When the control channel C23 is not in failure in Step S4 (NO in S4), normal processing by the ChannelFail message described for prior art (see FIGS. 19 and 20) is executed (S11).

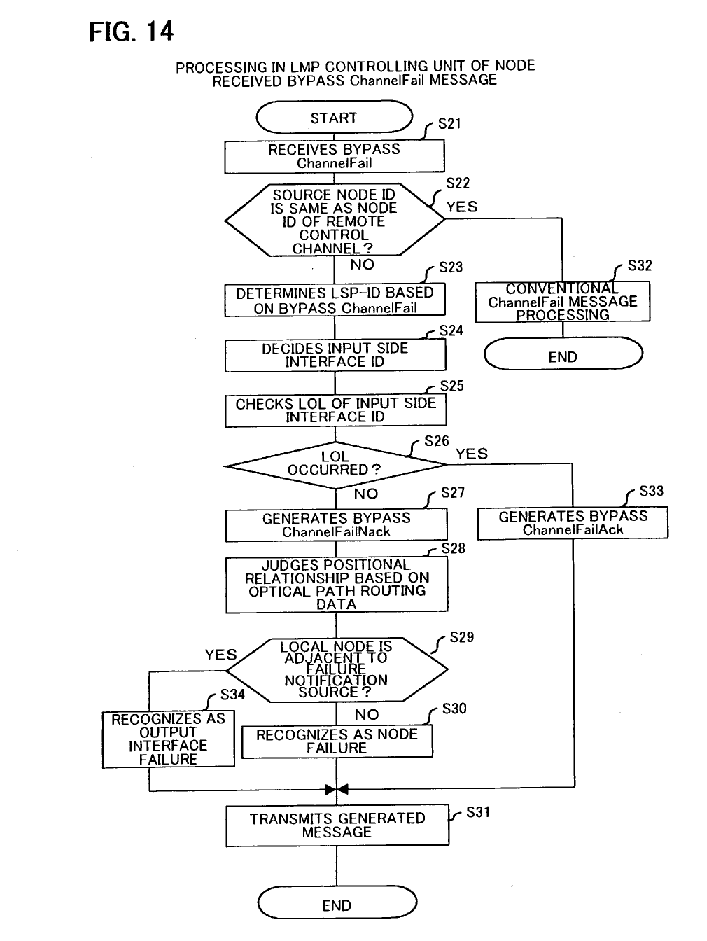

Then processing at the node which received the bypass ChannelFail message (node N2 in this case) will be described. FIG. 14 is a flow chart depicting the processing flow of the LMP controlling unit 19 of the node which received the bypass ChannelFail message.

When the LMP controlling unit 19_{N2} of the node N2 receives the bypass ChannelFail message (S21), the LMP controlling unit 19_{N2} compares the transmission source node ID “N3” in the IP header of the received bypass ChannelFail message and the remote note ID corresponding to the CCID “D” which received the ChannelFail message (“N5” in this case) (S22). This remote node ID is determined based on the control channel management data held by the LMP controlling unit 19_{N2} of the node N2.

When both the node IDs are the same (YES in S22), the LMP controlling unit 19_{N2} executes normal ChannelFail message processing (S32). When both the node IDs are not the same (N2≠N5), just like the failure example shown in FIG. 4 (NO in S22), the LMP controlling unit 19_{N2} judges that the received message is a bypass ChannelFail message which is different from a normal ChannelFail message, and executes the following processing.

In other words, the LMP controlling unit 19_{N2} of the node N2 determines the LSP-ID (optical path ID “#a” in this case) based on the optical path ID (see FIG. 11A) included in the received bypass ChannelFail message (S23).

Then the LMP controlling unit 19_{N2} searches the optical path management data corresponding to the LSP-ID “#a” (see FIG. 7), and determines the input side interface ID based on the searched optical path management data (S24). This input side interface ID corresponds with the input side optical wavelength label of the optical path management data of the LSP-ID “#a” one to one (in the present embodiment, the interface ID has the same value as the optical wavelength label), so the input side interface ID can be determined by the input side optical wavelength label. In other words, the LMP controlling unit 19_{N2} determines the input side interface ID “A-1” at the node N2 of the failed optical path #a.

Then the LMP controlling unit 19_{N2} checks whether LOL has occurred to the data channel of the input side interface ID “A-1” (S25).

If LOL has not occurred to the data channel of this input side interface ID (that is no failure occurred to the upstream side data channel of the node N2) (NO in S26), this means that a failure occurred between the nodes N2 and N3. Therefore the LMP controlling unit 19_{N2} generates the bypass ChannelFailNack message (see FIG. 11C) as response information (S27). Since the bypass ChannelFailNack message is sent along the bypass route, it is different from the normal ChannelFail Nack message described for prior art. The destination node of the IP header of the bypass ChannelFailNack message is the node N3, which is the transmission source node of the bypass ChannelFail message, and the content of the corresponding part of the bypass ChannelFail message is set as is for the local TE link ID and Failure TLVs.

Then the LMP controlling unit 19_{N2} receives the optical path management data corresponding to the LSP-ID “#a” determined in Step S23 from the signaling controlling unit 18_{N2}, and judges the positional relationship between the local node N2 and the transmission source node N3 of the bypass ChannelFail message (S28).

As the failure occurrence example in FIG. 4 shows, if the transmission source node N3 is adjacent to the local node N2 (YES in S29), then the LMP controlling unit 19_{N2} judges that failure occurred to the output side interface (data channel) B-2 from the local node N2 to the adjacent node N3. This is because a failure is not detected in the upstream side data channel of the node N2 (NO in S26) and the node N3 which detected failure of the data channel is the node adjacent to the local node N2 at the downstream side.

If the transmission node N3 is not adjacent to the local node N2 (NO in S29) anymore, on the other hand, the LMP controlling unit 19_{N2} of the node N2 judges that failure occurred to the node between the transmission node (failure notification source node) N3 and the local node N2 (S30).

Then the bypass ChannelFailNack message created in Step S27 is transmitted from the CCID “D” which received the bypass ChannelFail message, and is transmitted to the node N3 via the nodes N5 and N6 by the routing processing (S31).

The LMP controlling unit 19_{N3} of the node N3 receives the bypass ChannelFailNack message from the node N6, that is, the control channel C36 of the CCID “C”, the LMP controlling unit 19_{N3} judges that it is not a normal ChannelFailNack message but is a notification of the bypass ChannelFailNack message. And the LMP controlling unit 19_{N3} of the node N3 provides the LSP-ID included in the bypass ChannelFailNack message to the signaling controlling unit 18_{N3} of the local node N3, and receives the optical path routing data corresponding to this LSP-ID.

Then the LMP controlling unit 19_{N3} judges that the transmission source of the bypass ChannelFailNack message is the adjacent node N2 based on the received optical path routing data and the transmission source node (node N2) included in the IP header of the bypass ChannelFailNack message, then recognizes that a failure occurred to the data channel between the nodes N2 and N3.

In this way, according to the present embodiment, a bypass route of the control channel can be determined and the failure location of the data channel can be discovered by the notification processing using the bypass route, even if failure occurs to a control channel.

After the failure location is discovered, each node can autonomously set the optical path (protection path) using a data channel which is different from the failed data channel, and can also notify the information on the failure location to NMS and so on and NMS can set the protection path. The protection path of the data channel may be an optical path along the bypass route (nodes N2-N6-N5-N3) of the control channel, or may be an optical path of another route.

In Step S26, if LOL has occurred to the data channel of the input side interface ID at the node N2 (YES in S26), the LMP controlling unit 19_{N2} generates the bypass ChannelFailAck message (see FIG. 11B) as response information (S33), and transmits this ChannelFailAck message to the node N3 from the CCID “D” which received the bypass ChannelFail message (S31). Since this bypass ChannelFailAck message is transmitted along the bypass route, it is different from the normal ChannelFailAck message described for prior art. For the optical path ID of the bypass ChannelFailAck message, the failed LSP-ID (#a in this case) is set. If LOL has occurred to the data channel of the input side interface ID of the node N2, the node N2 also transmits the bypass ChannelFail message to the upstream side node, just like the node N3, and discovers the failure location.

Now processing when the route is not decided in Step S43 in the bypass route deciding processing in FIG. 13 will be described.

If a route to the node N2, which is the adjacent node, is not determined, the LMP controlling unit 19_{N3} of the node N3 determines a node positioned at the N stages upstream side (N is 2 or higher integer) from the local node N2 along the optical path #a. For this, the LMP controlling unit 19_{N3} sets “2” as the initial value of the parameter N for specifying a note at the N stage upstream side (S44).

Then the LMP controlling unit 19_{N3} decides the node at the N stages upstream side on the optical path #a with reference to the optical path routing data held by the signaling controlling unit 18_{N3}, and regards this node as the bypass destination node (S45). Here the optical path #a is the route of the nodes N1-N2-N3-N4, so when N=2, the bypass destination node is the node N1.

Then the LMP controlling unit 19_{N3} requests the routing controlling unit 20_{N3} to search the route to the bypass destination node N1 (S46). For searching the route, the Dijkstra algorithm of OSPF can be used, as mentioned above. If the Dijkstra algorithm is used, the shortest route is determined based on the topology data where the node N2, that is the node at the 1 stage upstream side (that is adjacent node at the upstream side) is erased. By this, the routing controlling unit 20_{N3} determines the shortest route to the node N1 “nodes N3-N6-N5-N1” (YES in S47), and notifies the data to indicate that “bypass route exists”, bypass route data, and CCID “C” to the LMP controlling unit 19_{N3} (S51).

Here as well, the erasure of the node N2 is advertised from the node N3 to the other nodes by LSA. By this, the other nodes can transmit the ChannelFail message sent from the node N3 to the node N1 via the bypass route which does not pass through the node N2, that is the “nodes N3-N6-N5-N1”.

If the bypass route is not determined with N=2 (NO in S47), the value of N is incremented by 1 each time (S48), and the bypass route to the node at the N stage upstream side is searched again. And if the bypass route is still not determined even when the bypass destination node is the node positioned at the start point (start edge) of the optical path, such as the node N1 (YES in S49), “no bypass route” is notified from the routing controlling unit 20_{N3} to the LMP controlling unit 19_{N3} (S50).

Even if a bypass route to the adjacent node is not determined, searching of the route is executed repeatedly until the bypass destination node becomes the node at the start point (start edge) of the optical path. Therefore various bypass paths which are available in the communication network system 1 are searched and the failure location can be discovered via the searched bypass path.

After notification in Step S51 or Step S50, the above mentioned processing in Step S7 and later by the LMP controlling unit 19 in FIG. 12 is executed. The node N1 which received the bypass ChannelFail message also executes the above mentioned processing shown in FIG. 14. And the node N1 transmits the bypass ChannelFailNack message to the node N3 if LOL has not occurred to the input side interface of the local node N1, and sends the bypass ChannelFailAck message to the node N3 if LOL has occurred.

The node N1 also judges whether failure occurred to the node N2 which exists between the local node N1 and the transmission node N3, since the transmission source node N3 of the bypass ChannelFail message is not an adjacent node. For example, the LMP controlling unit 19_{N1} of the node N1 receives the interface B-1 of the node N1 corresponding to the LSP-ID “#a” and the CCID “B” corresponding to the interface B-1, for example, from the signaling controlling unit 19_{N1}. And if the status of the control channel B (C12) is failure, the LMP controlling unit 19_{N1} can judge that it is a node failure of the node N2. And if the status of the control channel B (C12) is normal, the LMP controlling unit 19_{N1} can judge that it is not a node failure of the node N2. In this way, the location where node failure occurred can also be determined.

The case when the data channel A-2 of the node N3 failed during failure of the control channel C23 was described above as an example, but the same processing is executed and the occurrence of failure is notified and the failure location is discovered as well when another control channel fails or another data channel fails.

The status of a control channel may be detected by (A) a time up of the interval timer for a Hello message, or may be detected by (B) notification from a lower layer, such as a signal OFF.

In the case of (A), the LMP to be executed by the control channel has a role to maintain the normalcy of a data link as a lower layer, so that such a routing protocol as OSPF and such a signaling protocol as RSVP, which correspond to a higher layer, can operate normally. For this, the draft of LMP defines transmitting a Hello message in a mili-second order as a simple link normality confirmation (Keep Alive) function. This Hello message is transmitted at an interval of the timer “HelloInterval”, which has been defined in advance between both the end nodes of the control channel. If the Hello message is not received, even when the time of the timer “HelloDeadInterval” at both the end nodes is up, then it is judged that the control channel is disconnected (failure occurred).

In (B), the occurrence of failure can be detected by LOL when an optical fiber link is used for the control channel, and loss of carrier in the physical layer (layer 1) can be judged as a failure when Ethernet is used for the control channel.

Each message format of the bypass ChannelFail message, bypass ChannelFailAck message, and bypass ChannelFailNack message can be used even if information according to the present embodiment is added to the message format of a conventional LMP, or a new message ID may be specified to create a separate message.

### Second Embodiment

In the first embodiment, the bypass route of the failed control channel is determined by the trigger of detecting the failure of the data channel (LOL), but the bypass route of the control channel can be predetermined by the trigger of detecting the failure of the control channel itself.

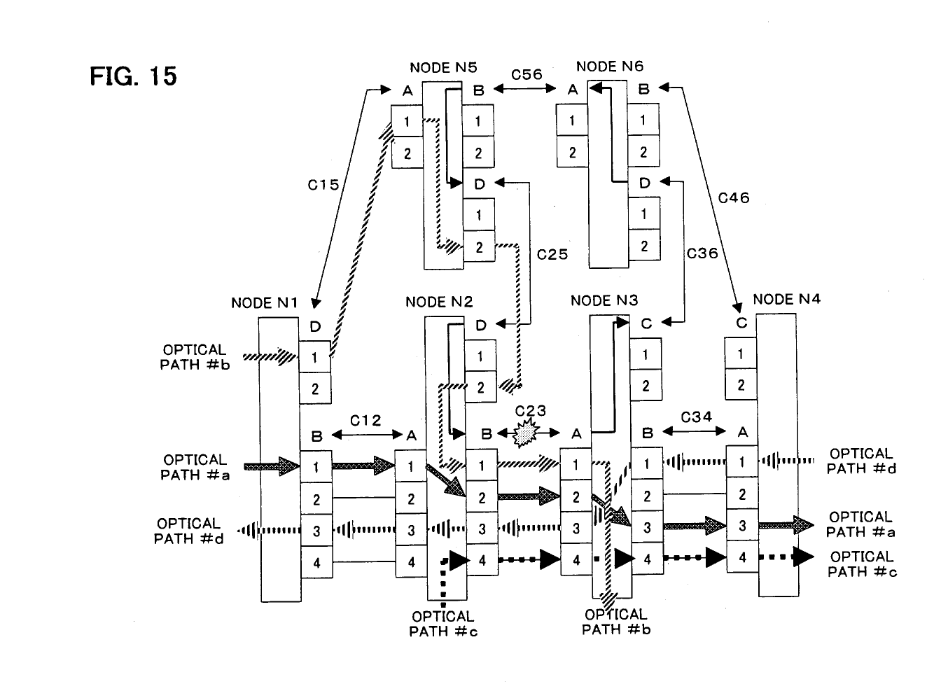

FIG. 15 shows how to set the bypass route of the control channel C23 of the optical transmission network system 1. In FIG. 15, detailed routes of the optical paths #b to #d are also shown, in addition to the optical path #a.

The optical path #b is a route passing through the interface D-1 of the node N1, interfaces A-1 and D-2 of the node N5, interfaces D-2 and B-1 of the node N2, and interface A-1 of the node N3. The optical path #c is a route passing through the interface B-4 of the node N2, interfaces A-4 and B-4 of the node N3, and interface A-4 of the node N4. The optical path #d is a route passing through the interface A-1 of the node N4, interfaces B-1 and A-3 of the node N3, interfaces B-3 and A-3 of the node N2, and interface B-3 of the node N1.

Now the processing to predetermine the bypass route of the control channel for the optical paths #a to #d, which use the control channel C23 triggered by a failure detection when a failure occurred to the control channel C23, will be described.

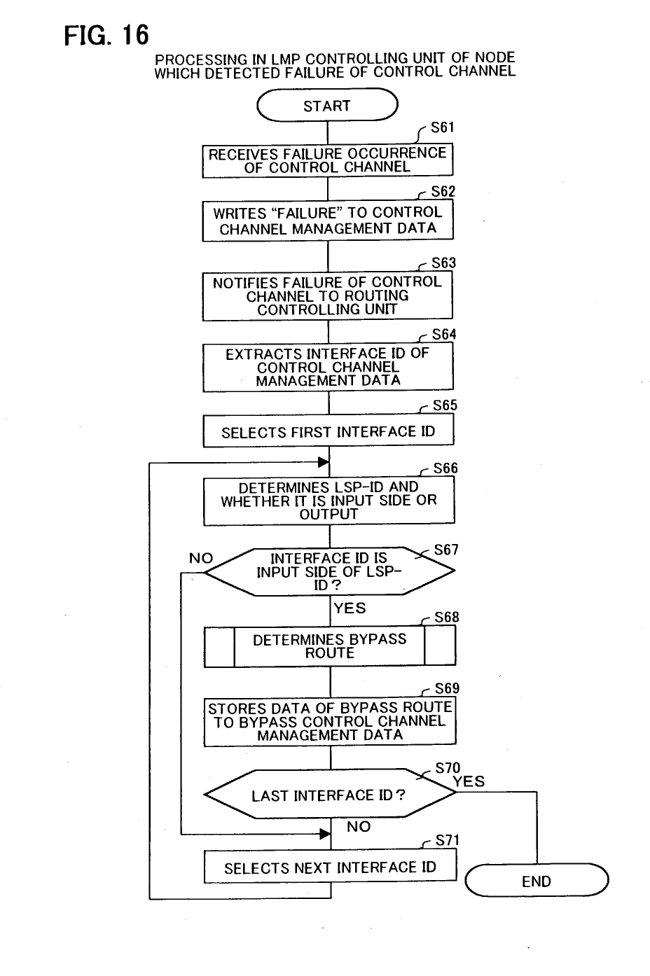

FIG. 16 is a flow chart depicting the processing flow of the LMP controlling unit.

When a failure occurs to the control channel C23, detection of a failure is notified to the LMP controlling units 19_{N2} and 19_{N3} of the nodes N2 and N3 respectively (S61). The LMP controlling unit 19_{N2} of the node N2 recognizes this as a failure of the control channel of the CCID “B”, and the LMP controlling unit 19_{N3} of the node N3 recognizes this as a failure of the control channel of the CCID “A”.

The LMP controlling unit 19_{N3} of the node N3 writes “Failure” to the control channel status of the control channel management data of the CCID “A” (S62).

Then the LMP controlling unit 19_{N3} notifies the routing controlling unit 20_{N3} that a failure occurred to the control channel C23 (S63). By this, the routing controlling unit 20_{N3} changes the topology of the optical transmission network system 1 to a topology where the control channel C23 does not exist, and advertises the change of the topology to the other nodes by LSA.

Then the LMP controlling unit 19_{N3} determines the interface (data channel) to be managed by the failed control channel C23 from the interface data of the control channel management data of the CCID “A” (see FIG. 8) (S64). In this case, the interface IDs “A-1” to “A-4” are determined.

Then the LMP controlling unit 19_{N3} determines the bypass route of the control channel for each one of the interface IDs from which signals are input to the local node N3 (interface IDs at input side of the optical path) out of the determined interface IDs (S65 to S71). In other words, the bypass route of the control channel is determined for all the data channels from which signals are input to the local node. By this, even if any of the data channels from which signals are input to the local node fails thereafter, the occurrence of failure can be notified and the failure location can be discovered by the bypass route of the control channel corresponding to the data channel.

At first, the LMP controlling unit 19_{N3} selects the first interface ID “A-1” of the determined interface ID, and provides the selected interface ID to the signaling controlling unit 18_{N3} (S65).

The signaling controlling unit 18_{N3} determines LSP-ID “#b” based on the optical path management data corresponding to the provided interface ID “A-1”, and returns the determined LSP-ID “#b” to the LMP controlling unit 19_{N3} (S66). The signaling controlling unit 18_{N3} judges which one of the input side optical wavelength label or the output side optical wavelength label the provided interface ID “A-1” corresponds to, and returns the value “input side” or “output side”, whichever corresponds to the interface ID “A-1” to the LMP controlling unit 18_{N3} (S66). “input side” is returned for the interface ID “A-1”.

Then the LMP controlling unit 19_{N3} judges whether the selected interface ID is the input side of the optical path using the value returned from the signaling controlling unit 18_{N3} (S67).

If the selected interface ID is “input side” (YES in S67), then the LMP controlling unit 19_{N3} determines the bypass route of the control channel C23 corresponding to the selected interface ID (that is the data channel) “A-1” (S69).

At first, the bypass route to the upstream side adjacent node N2 is determined since the optical path using the control channel C23 always passes through the upstream side adjustment node N2. This bypass route is determined by the processing in Steps S41 and S42 in FIG. 13 in the above mentioned first embodiment.

The data on the determined bypass route is stored to the bypass control channel management data (see FIG. 7) of the optical path management data of the optical path #b. This data of the bypass route includes the bypass destination node ID “N2” and the bypass control channel routing data (node ID string N6, N5 and N2 on the route).

Then the bypass route to the node located at a more upstream side (node at N stage upstream side) on the optical path is determined. This bypass route is determined by the processing in Steps S44 to S49 in FIG. 13. For the optical path #b corresponding to the interface ID “A-1”, for example, the bypass route to the node N5 and the bypass route to the node N1 are determined. The data on the determined bypass route is stored to the bypass control channel management data (see FIG. 7) of the optical path management data of the optical path #b.

For the bypass control channel management data, priority, such as the first candidate and the second candidate, is determined from the data where the distance on the optical path from the node N3 for which failure was detected is the shorter. For example, priority is assigned such that the bypass control channel management data to the node N2 is the first candidate, the bypass control channel management data to the node N5 is the second candidate, and the bypass control channel management data to the node N1 is the third candidate.

For the other interface IDs at the input side, “A-2” and “A-4” as well, the bypass route of the control channel C23 is determined, and the data of each bypass route is stored in the bypass control channel management data (S66 to S71). By this, for the interface ID “A-2”, bypass control channel management data is stored in the optical path management data of the optical path #a, and for the interface ID “A-4”, the bypass control channel management data is stored for the optical path management data of the optical path #c.

For the optical path #c, the upstream side adjacent node N2 is a node located at the edge of the optical path, and the bypass route to the node at the N stage upstream side cannot be determined.

The LMP controlling unit 19_{N2} of the node N2, on the other hand, determines the bypass route of the control channel C23 for the input side interface ID “B-3”. In other words, the bypass route to the upstream side adjacent node N3 and the bypass route to the two-stage upstream side node N4 on the optical path #d are determined, and these data are stored for the bypass control channel management data of the optical path management data of the optical path #d.

For the bypass control channel management data, the CCID of each bypass route output path (e.g. CCID “C” of node N3) in the failure detected node may be added.

When failure occurs to the data channel and LOL is detected after that, the status of the control channel corresponding to the data channel is checked, and if this control channel is “Failure”, the bypass ChannelFail message can be transmitted immediately based on the already determined bypass control channel management data. By this, the failure location can be quickly determined.

If LOL is detected at the interface ID “A-2” of the node N3, for example, the LMP controlling unit 19_{N3} checks the LSP-ID which uses the interface ID “A-2” and knows that the failed path is the optical path #a by the data channel management data since the control channel A is “Failure”. And the LMP controlling unit 19_{N3} determines the output path C of the first candidate destination node N2 by the bypass control channel management data of the optical path management data of the optical path #a, and immediately transmits the bypass ChannelFail message from the output path C to the destination node N2.

The relay nodes of the bypass ChannelFail message, nodes N6 and N5, have already received LSA, just like the first embodiment, so the bypass Channel Fail message can be transferred to the node N2. Also the node N2 processes the bypass ChannelFail message, just like the first embodiment, and replies the bypass ChannelFailNack to the node N3.

By predetermining the bypass route of the control channel for each optical path triggered by the detection of failure of a control channel, as mentioned above, failure can be notified, and the failure location can be discovered using the bypass route at high-speed when failure occurs to the data channel.

### Third Embodiment

When a data channel failure is detected, the protection switching of the path of the data channel can be executed simultaneously, in addition to a search of the bypass control channel.

In order to execute the protection switching of the path of the data channel, according to the present embodiment, if a failure is detected in the data channel in a state where failure is detected in the control channel, the bypass Path message, instead of the bypass ChannelFail message, is sent from the downstream side node to the upstream side node, in the reverse direction on the bypass route. This bypass Path message is the Path message (see FIG. 6A), that is a signaling message of RSVP-TE, which includes information equivalent to the bypass ChannelFail message in the first embodiment.

Also, in the present embodiment, label reservation by the bypass Path message is executed to set an optical path on the bypass route, unlike normal GMPLS label distribution (label distribution by a Resv message). For this, bi-directional paths are set by the Path-Resv sequence all at once by the Upstream Label object included in the bypass Path message, where a normal Label object for securing a label for downstream is not used.

Further, according to the first embodiment and the second embodiment, nodes which relay the bypass ChannelFail message, bypass ChannelFailAck message, and bypass ChannelFailNack message (nodes N4 and N5 in FIG. 4) merely route these messages, and do not terminate them, but according to the present embodiment, the node which relays such messages as the bypass Path message executes processing for terminating a message for setting the bypass optical path.

Now the present embodiment will be described in detail using the failure occurrence example in FIG. 4.

The LMP controlling unit 19_{N3} in the node N3 receives the failure notification of the data channel A-2 of the optical path #a, and the LMP controlling unit 19_{N3} requests the signaling controlling unit 18_{N3} for bypassing the failure location.

The signaling controlling unit 18_{N3} determines the LSP-ID “#a” from the interface ID “A-2” where failure is detected, based on the data channel management data (see FIG. 9). And the signaling controlling unit 18_{N3} fetches the optical path routing data (nodes N1-N2-N3-N4) of the optical path #a from the optical path management data corresponding to LSP-ID “#a” (see FIG. 7).

Then the signaling controlling unit 18_{N3} has the routing controlling unit 20_{N3} search the route up to the upstream side adjacent node N2 based on the topology data, where the link directly connecting the local node N3 and the upstream side adjacent node N2 is erased, by the above mentioned bypass route deciding processing in FIG. 13. By this the routing controlling unit 20_{N3} determines the bypass route to the node N2, “nodes N3-N6-N5-N2”, and provides the optical path routing data of this bypass route to the signaling controlling unit 18_{N3}.

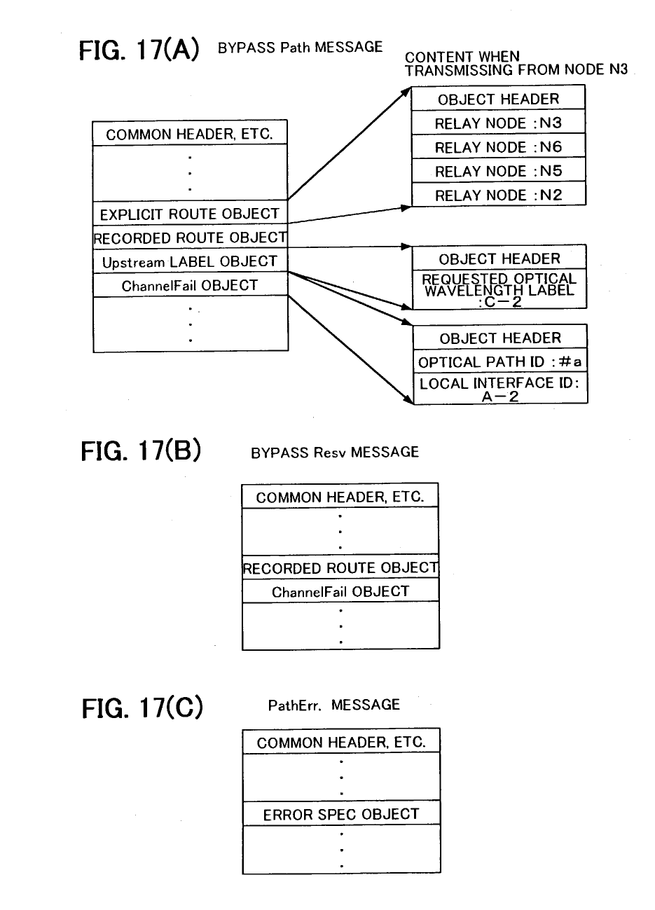

Then the signaling controlling unit 18_{N3} transmits the bypass Path message to the adjacent node N6 on the bypass route. FIG. 17A shows a configuration example of the bypass Path message, where the specific content of the bypass Path message to be sent from the node N3 to the node N6 is shown as an example.

This bypass Path message is almost the same as the above mentioned Path message shown in FIG. 6A, but in this bypass Path message, Upstream Label Object, which is normally used for setting the bi-directional paths by one Path-Resv sequence, is used so that the path in the opposite direction from the Path message can be set. This Upstream Label Object includes the required optical wavelength label.

This required wavelength label is an optical wavelength label which the node N3 requests the upstream side adjacent node N6 to secure on the bypass route (protection path) of the optical path #a where failure is detected. The data channel signal from the node N6 to the node N3 is received by the node N3 with this required optical wavelength label. For this required wavelength label, the optical wavelength label, which is available in the local node, is set by the signaling controlling unit 18_{N3} of the node N3, and “C-2” is set in the case of the example shown in FIG. 17A.

For the bypass Path message, an area of Channel Fail Object is newly provided. In this area, information on the bypass ChannelFail message (see FIG. 11A) is incorporated. In the case of the failure example in FIG. 4, the optical path ID “#a” and the local interface ID “A-2” where failure is detected are stored in the area of Channel Fail Object. In the Explicit Route Object, path data of the bypass route is stored. This Channel Fail Object is processed only at the terminating node N2.

When the relay node N6 receives the bypass Path message from the node N3, the relay node N6 checks whether it is possible to secure a resource in the Upstream direction (direction from the node N6 to the required wavelength label “C-2” of the node N3) by the required wavelength label of Upstream Label Object included in the bypass Path message. The node N6, on the other hand, does not check whether it is possible to secure a resource in the downstream direction (direction from the node N3 to the node N6). This is different from the normal processing for a Path message, where it is checked whether a resource in the downstream direction can be secured.

If it is possible to secure a resource in the upstream direction, the relay node N6 secures the resource, and sets the new required wavelength label in the node N6 to the Upstream Label Object of the bypass Path message. And the relay node N6 pops the node information (local node ID) at the first position of Explicit Route Object, and sends the bypass Path message to the node (node N5) which is at the first position after popping in the node information.

The relay node N5 also executes the same processing as the node N6, secures a resource in the upstream direction (direction from the node N5 to the node N6), and transmits the bypass Path message to the terminating node N2.

Routing of the bypass Path message to the destination node N2 is executed by advertising the LSA of OSPF to the nodes N5 and N6 in advance along the bypass route N3-N6-N5-N2, just like the first and second embodiments.

When the bypass Path message is transmitted to the node N2 like this, the node N2 executes the termination processing of the bypass Path message. The node N2 can know that the local node is the termination node by Explicit Route Object or Recorded Route Object of the bypass Path message.

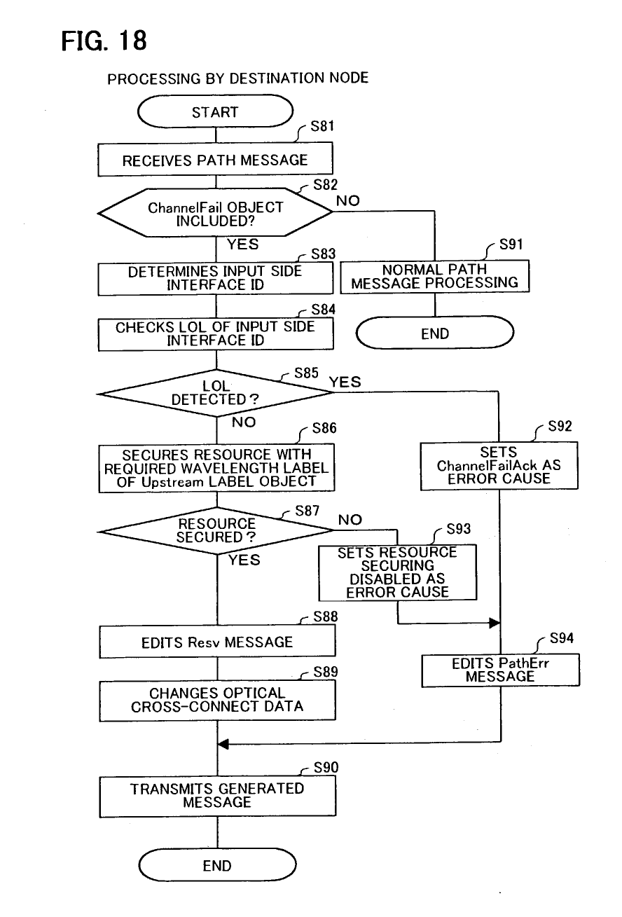

FIG. 18 is a flow chart depicting the processing flow of the termination node (destination node).

When the signaling controlling unit 18_{N2} of the node N2 receives the bypass Path message (S81), the signaling controlling unit 18_{N2} judges whether Channel Fail Object is included in the bypass Path message (S82).

If Channel Fail Object is included (YES in S82), the signaling controlling unit 18_{N2}determines the input side interface ID as “A-1” of the optical path ID #a” in the node N2 based on the optical path management data corresponding to the optical path ID (LSP-ID) “#a” of Channel Fail Object.

The determined input side interface ID is provided to the LMP controlling unit 19_{N2}, and the LMP controlling unit 19_{N2} checks whether LOL is detected on the provided input side interface ID (S84).

If LOL is detected (YES in S84), it means that failure of the optical path #a occurred to a more upstream side optical fiber link or node. Therefore in this case, the failure cannot be bypassed, even if a bypass optical path is set from the node N2 to the node N3. So the node N2 stores ChannelFailAck to the Error Spec Object of the PathErr message (see FIG. 17C) as an error cause so that the bypass path is not set (S92, S94), and replies this PathErr message to the node N3.

If LOL is not detected (NO in S85), it means that the failure occurred between the nodes N2 and N3. Therefore the node N2 executes the bypass optical path setting processing (S86 and so on). In other words, the LMP controlling unit 19_{N2} of the node N2 attempts to secure a resource of the optical path #a with the required optical wavelength label of the Upstream Label Object, just like the relay node N6 (S86).

If the resource is not secured (NO in S87), the signaling controlling unit 18_{N2} stores “resource securing disabled” to Error Spec Object of the PathErr message (See FIG. 17C) as an error cause (S93, S94), and replies this PathErr message to the node N3.

If the resource is secured (YES in S87), the signaling controlling unit 18_{N2}replies the secured label value to the node N3 using the bypass Resv message (see FIG. 17B).

The signaling controlling unit 18_{N2}also has the optical path management controlling unit 21_{N2} change the optical cross-connect data via the LMP controlling unit 19_{N2} (see FIG. 10). For example, the optical cross-connect data is changed such that in node N2, the data channel signal of the input side interface ID “A-1” is switched to the output side interface ID “D-1” to the node N5, for example. By this, the data channel signal of the optical path #a from the node N1 is switched to the node N5.

The signaling controlling unit 18_{N2} can also notify the node N3 that LOL was not detected by storing the data included in the Failure TLVs of ChannelFailNack (see FIG. 11C) to the Channel Failure Object of the bypass Resv message, and reply the data to the Channel Fail Object included in the bypass Path message. As a result, the node N3 can discover the failure location.

The relay nodes N5 and N6, which received the bypass Resv message from the node N2, have already reserved the optical wavelength label by the Upstream Label Object of the bypass Path message. Therefore the nodes N5 and N6 can execute the optical cross-connect and start the switching of data channel signals.

The relay nodes N5 and N6 can distinguish between the 10 bypass Resv message and the normal Resv message by the presence of the Channel Fail Object. Or these messages may be distinguished by putting a different message identifiers. And for the bypass message, the above mentioned processing for setting the bypass path is executed.

For the ChannelFailAck information and ChannelFailNack information included in the bypass Resv message, the relay nodes N5 and N6 do not have to terminate. This is the same for a PathErr message.

The signaling controlling unit 18_{N3} of the node N3 which received the bypass Resv message recognizes that the optical path #a is the optical path where LOL is being detected by the optical path ID “#a” included in the Channel Failure Object of the bypass Resv message.

Then the signaling controlling unit 18_{N3} provides the local interface ID “A-2” included in the Channel Failure Object of the bypass Resv message to the LMP controlling unit 19_{N3}, and makes the LMP controlling unit 19_{N3} change the interface ID “A-2” to the interface ID “C-2” of the optical wavelength label (corresponding to the required optical wavelength label of the bypass Path message) included in the bypass Resv message.

The LMP controlling unit 19_{N3} has the optical path management controlling unit 21_{N3} change the input side interface ID “A-2” of the optical cross-connect data of the optical path #a to the interface ID “C-2”. By this, the working optical path #a “nodes N1-N2-N3-N4” is changed to the bypass route (protection path) “nodes N1-N2-N5-N6-N3”, and the data channel signals of the optical path #a are transmitted by this bypass route.

The LMP controlling unit 19_{N3} processes the ChannelFailNack information included in the bypass Resv message in the same way as the first embodiment, and discovers the failure location.

If the PathErr message is received by the node N3, on the other hand, the resource cannot be secured by this route. In this case, path setting using another route to the node N2, which is the destination node, may be attempted by the crank back method which is used for conventional signaling technology, or node bypassing to the node N1 bypassing the node N2 may be attempted.

If the route to the node N2 cannot be found, the bypass route to the node N1 at a more upstream side is searched, just like the above mentioned first embodiment, and such messages as the bypass Path message and the bypass Resv message shown in FIG. 17 are communicated via the searched bypass route. In the node N1, processing the same as node N2 is executed.

In this way, the bypass optical path (protection path) can be set along with the failure notification.

### Other Embodiments

In the above described embodiments, an individual optical fiber is set for a data channel and for a control channel respectively, but the same optical fiber may be used as an optical fiber for a data channel and an optical fiber for a control channel. In this case, a different wavelength is assigned to the data channel and the control channel respectively, and both channels are wavelength division multiplexed on the same optical fiber.

The bypass route is one example, so if an optical fiber for a protection path directly connecting the nodes N2 and N3 is installed, for example, the bypass route may be set on this optical fiber. The bypass route to be selected depends on the route searching algorithm of the routing controlling unit 20.

According to the present invention, in the transmission network system where a data channel and a control channel are installed independently, failure can be notified and the failure location can be discovered even if the failures in a data channel, control channel or transmission system occur at the same time. Because of this, an appropriate protection path can be set promptly, and the working path can be switched to the protection path.

For example, in an optical transmission network using OXC nodes, if a failure occurs to a node or control channel which controls a failed optical path, the failure information is notified to the most appropriate upstream node by uniquely routing the bypass route by the control channel. By this, the failure location can be discovered, which was conventionally impossible when a control channel failed, and local bypassing, which is essential for a mesh type network configuration with high flexibility, can be executed appropriately.

Failure is detected not at the end of the optical path, but at each node in the middle of the optical path, and the node which detected failure notifies the failure to the most appropriate upstream node. By this, the nodes can discover the failure location, and protection path bypassing the failure location can be set accurately and quickly. As a result, in a mesh type network, the failure location can be discovered regardless the status of the control channel, and the failure location can be locally bypassed.

Therefore for both a data channel and a control channel, local bypassing can be performed appropriately, so a network resources which are especially prepared in advance as a redundant system can be decreased. Also a low cost network can be implemented while maintaining high reliability.

Also each node saves a control channel autonomously, so the survivability of a control channel naturally improves without requiring the attention of network maintenance and management personnel, and network setting and maintenance by GMPLS can be dramatically simplified.

What is claimed is:

1. A transmission device in a transmission network system having a plurality of transmission devices and providing a data channel for transmitting data signals and a control channel for transmitting control signals individually between the transmission devices, said data signals being transmitted along a preset path, comprising:
a first failure detecting unit for detecting a failure of a working control channel which transmits control signals for controlling a working data channel for transmitting data signals to be input along a working path set at its transmission device from a transmission device adjacent to an upstream side on said working path;
a second failure detecting unit for detecting a failure of said working data channel;
a route searching unit for searching a route of a protection control channel for the working control channel, in which a failure is detected by said first failure detecting unit, between its transmission device and a transmission device located at the upstream side on said working path; and
a transmission unit for transmitting information on the failure detected by said second failure detecting unit to said transmission device located at the upstream side by the protection control channel along the route searched by said route searching unit.

2. The transmission device according to claim 1, wherein said route searching unit searches the route of said protection control channel when said second failure detecting unit detects a failure after failure detection by said first failure detecting unit.

3. The transmission device according to claim 2, wherein said transmission unit transmits information for securing a protection path for said working path along the route of said protection control channel, in addition to said information on failure, to said transmission device located at the upstream side.

4. The transmission device according to claim 1, wherein said route searching unit searches the route of said protection control channel regardless whether a failure is detected by said second failure detecting unit during failure detection by said first failure detecting unit.

5. The transmission device according to claim 1, further comprising a reception unit for receiving response information to said information on failure replied from said transmission device located at the upstream side through said protection control channel.

6. The transmission device according to claim 5, further comprising a judgment unit for judging an occurrence location of the failure detected by said second failure detecting unit based on said response information, and positional relationship between the transmission device which replied said response information and its transmission device.

7. The transmission device according to claim 1, wherein said route searching unit searches the route of said protection control channel between its transmission device and said transmission device adjacent to the upstream side on said working path.

8. The transmission device according to claim 7, wherein when the route of said protection control channel cannot be searched between its transmission device and said transmission device adjacent to the upstream side on said working path, said route searching unit searches the route of said protection control channel between its transmission device and a transmission device located further at the upstream side on said working path.

9. A transmission device in a transmission network system having a plurality of transmission devices and providing a data channel for transmitting data signals and a control channel for transmitting control signals individually between the transmission devices, said data signals being transmitted along a preset path, comprising:
a reception unit for receiving information on a failure of a working data channel, said information on the failure being sent from a transmission device located at a downstream side on a working path set at its transmission device via a protection control channel for a working control channel of said transmission device located at the downstream side;
a failure detecting unit for detecting a failure of the working data channel for transmitting data signals to be input along said working path; and
a judgment unit for judging an occurrence location of the failure based on positional relationship between its transmission device and said transmission device positioned at the downstream side, and presence of failure detected by said failure detecting unit.

10. The transmission device according to claim 9, wherein said judgment unit judges that the failure has occurred at the upstream side of its transmission device if said failure detecting unit detects the failure, and judges that the failure has occurred between its transmission device and said transmission device located at the downstream side if said failure detecting unit does not detect the failure.

11. The transmission device according to claim 9, further comprising a transmission unit for replying response information corresponding to the judgment result of said judgment unit to said transmission device located at the downstream side.

12. The transmission device according to claim 9, wherein said reception unit receives information for securing a protection path for said working path, in addition to the information on said failure, from said transmission device located at the downstream side via said protection control channel, and said transmission device further comprises a path setting unit for securing said protection path according to the information for securing said protection path.

13. A transmission device in a transmission network system having a plurality of transmission devices and providing a data channel for transmitting data signals and a control channel for transmitting control signals individually between the transmission devices, said data signals being transmitted along a preset path, comprising:
a reception unit for receiving information on failure of a working data channel for transmitting data signals to be input to a first transmission device along a working path, said first transmission device being located at a downstream side of said working path, said information on failure being transmitted from said first transmission device to a second transmission device located at an upstream side of said working path via a protection control channel for a working control channel of said first and second transmission device, said working control channel being provided along said working path; and
a transmission unit for transmitting said information on failure received by said reception unit via said protection control channel so that said information is received by said second transmission device.

14. The transmission device according to claim 13, wherein said reception unit receives information for securing a protection path for said working path in addition to said information on failure, and said transmission device further comprises a path setting unit for securing said protection path according to said information for securing said protection path.

15. A transmission network system having a plurality of transmission devices and providing a data channel for transmitting data signals and a control channel for transmitting control signals individually between the transmission devices, said data signals being transmitted along a preset path, comprising:
a first transmission device located at a downstream side of a working path being set;
a second transmission device located at an upstream side of said working path being set; and
a third transmission device for relaying information communicated between said first transmission device and said second transmission device,
wherein said first transmission device comprises:
a first failure detecting unit for detecting a failure of a working control channel which transmits control signals for controlling a first working data channel, said first working data channel transmitting data signals to be input from a transmission device adjacent to an upstream side on said working path along said working path;
a second failure detecting unit for detecting a failure of said first working data channel;
a route searching unit for searching a route of a protection control channel of the working control channel where a failure is detected by said first failure detecting unit between said first transmission device and said second transmission device; and
a first transmission unit for transmitting information on the failure detected by said second failure detecting unit to said second transmission device by a protection control channel along the route searched by said route searching unit,
said third transmission device comprises:
a first reception unit for receiving said information transmitted by said first transmission unit via said protection control channel when said third transmission device positions on the route searched by said route searching unit; and
a second transmission unit for transmitting said information via said protection control channel so that said information received by said reception unit is received by said second transmission device, and
said second transmission device further comprises:
a second reception unit for receiving said information transmitted from said first transmission device via said second transmission device;
a third failure detecting unit for detecting a failure of a second working data channel for transmitting data signal to be input along said working path; and
a judgment unit for judging said failure location based on positional relationship between said second transmission device and said first transmission device, and based on presence of the failure detected by said third failure detecting unit.
